(19) United States
(12) Patent Application Publication
(10) Pub. No.: US 2017/0032349 A1
(43) Pub. Date: Feb. 2, 2017

(54) INFORMATION PROCESSING APPARATUS

(71) Applicants: NEC Solution Innovators, Ltd., Tokyo (JP); NEC Corporation, Tokyo (JP)

(72) Inventors: Yukio NISHIDA, Tokyo (JP); Tomoko SENDAI, Tokyo (JP); Noriyoshi HIROI, Tokyo (JP)

(73) Assignees: NEC Solution Innovators, Ltd., Tokyo (JP); NEC Corporation, Tokyo (JP)

(21) Appl. No.: 15/303,158

(22) PCT Filed: Mar. 4, 2015
(86) PCT No.: PCT/JP2015/056303

§ 371 Date: Oct. 10, 2016

(30) Foreign Application Priority Data
Apr. 18, 2014 (JP) 2014-086508

(51) Int. Cl. G06Q 20/20; G06K 7/14; G06K 19/06

(52) U.S. Cl. CPC G06Q 20/204; G06K 19/06037; G06K 7/1417

(57) ABSTRACT

An information processing apparatus (100) includes a symbol detection unit (101) that detects an identification symbol included in an object based on sensor information, and an association unit (102) that associates, in accordance with a positional relationship between a commodity or a commodity symbol corresponding to the commodity and the object including the detected identification symbol, identification information obtained using the detected identification symbol with information on the commodity.

### TECHNICAL FIELD

The present invention relates to a technique for assisting purchase of a commodity, and the like.

### BACKGROUND ART

At present, there are various purchasing methods, such as Internet shopping, television shopping, and shopping at a brick-and-mortar store. In each of the purchasing methods, assistance of the customer's act of purchasing is being variously devised. For example, in many Internet shopping sites, an electronic shopping cart is provided, and the customer can tentatively keep desirable commodities in the cart. Thereby, the customer can finally select a commodity that the customer desires to purchase from a group of commodities which are in the cart, at the time of confirming an order.

In Patent Document 1 described below, a purchasing method is proposed which eliminates the need for a customer to carry commodities that the customer plans to purchase in a shopping cart or the like at a brick-and-mortar store such as a supermarket or a mass retailer. Specifically, an IC tag is disposed for each commodity, and the customer allows a handy terminal to read the charge data and commodity code data of a desired commodity from the IC tag of the commodity and hands the handy terminal to a store clerk at a cash register. The store clerk performs an accounting process based on the commodity information and a total price that are displayed on the handy terminal, and prepares the commodities for purchase.

### RELATED DOCUMENT

### Patent Document

[Patent Document 1] Japanese Laid-open Patent Application Publication No. 2002-8134

### SUMMARY OF THE INVENTION

However, in any of the above-mentioned purchasing methods, the customer is required to make efforts to a certain extent. For example, in the proposed method mentioned above, the customer is required to carry the handy terminal in the store and make the handy terminal read an IC tag of a commodity. In particular, such an act is a burden for a customer who is not used to the operation of electronic equipment. In addition, in Internet shopping, a customer must prepare a user terminal (Personal Computer (PC), a smart device, or the like) which is connectable to the Internet and a communication environment and operate the user terminal to access a specific Electronic Commerce (EC) site.

The present invention is contrived in view of such situations and provides a technique for assisting purchasing and the like. The wording “assisting purchasing and the like” as used herein includes not only assistance to an act of purchasing but also assistance before and after the purchase.

In aspects of the invention, the following configurations are adopted in order to solve the above-described problems.

A first aspect relates to an information processing apparatus. The information processing apparatus according to the first aspect includes a symbol detection unit that detects an identification symbol included in an object based on sensor information, and an association unit that associates, in accordance with a positional relationship between a commodity or a commodity symbol corresponding to the commodity and the object including the detected identification symbol, identification information obtained using the detected identification symbol with information on the commodity.

A second aspect relates to a purchase assisting method executed by at least one computer. The purchase assisting method according to the second aspect includes detecting an identification symbol included in an object based on sensor information, and associating, in accordance with a positional relationship between a commodity or a commodity symbol corresponding to the commodity and the object including the detected identification symbol, identification information obtained using the detected identification symbol with information on the commodity.

Meanwhile, another aspect of the invention may be a program causing at least one computer to execute the method of the above-described second aspect, or may be a computer readable recording medium having the program recorded thereon. The recording medium includes a non-transitory tangible medium.

According to the above-described aspects, it is possible to provide a technique for assisting purchasing and the like.

### BRIEF DESCRIPTION OF THE DRAWINGS

The above-described objects, other objects, features and advantages will be further apparent from the preferred exemplary embodiments described below, and the accompanying drawings as follows.

FIG. 1 is a schematic diagram showing a system configuration of a purchase assisting system according to a first exemplary embodiment.

FIG. 2 is a schematic diagram showing a processing configuration example of a purchase assisting server according to the first exemplary embodiment.

FIG. 3 is a diagram showing an example of association information which is retained in a retaining unit.

FIG. 4 is a flow chart showing an operation example at the time of setting a candidate to be purchased of the purchase assisting server according to the first exemplary embodiment.

FIG. 5 is a diagram showing a specific example of a portable object.

FIG. 6 is a diagram showing a specific example of a commodity display shelf.

FIG. 7 is a flow chart showing an operation example of the purchase assisting server at checkout according to the first exemplary embodiment.

FIG. 8 is a schematic diagram showing a system configuration of a purchase assisting system according to a second exemplary embodiment.

FIG. 9 is a schematic diagram showing a processing configuration example of the purchase assisting server according to the second exemplary embodiment.

FIG. 10 is a flow chart showing an operation example at the time of setting a candidate to be purchased in the purchase assisting server according to the second exemplary embodiment.

FIG. 11 is a flow chart showing an operation example of the purchase assisting server at checkout according to the second exemplary embodiment.

FIG. 12 is a schematic diagram showing an example of an operation scene according to the second exemplary embodiment.

FIG. 13 is a schematic diagram showing a processing configuration example of an information processing apparatus according to a third exemplary embodiment.

FIG. 14 is a flow chart showing an operation example of the information processing apparatus according to the third exemplary embodiment.

FIG. 15 is a diagram showing a configuration example of an interactive projection device (IP device).

FIG. 16 is a schematic diagram showing an operation scene of this example.

FIG. 17 is a diagram showing an example of a menu screen.

FIG. 18 is a diagram showing an example of an electronic books list screen.

FIG. 19 is a diagram showing an example of a book image.

FIG. 20 is a diagram showing an example of a user's operation with respect to a book image (commodity symbol).

FIG. 21 is a diagram showing an example of a projection image after a commodity is input.

FIG. 22 is a schematic diagram showing the issuance of a ticket after payment at a cash register.

### DESCRIPTION OF EXEMPLARY EMBODIMENTS

Hereinafter, exemplary embodiments of the invention will be described. Meanwhile, the exemplary embodiments described below are just examples, and the invention is not limited to following configuration of the respective exemplary embodiments.

### First Exemplary Embodiment

Hereinafter, a purchase assisting system and a purchase assisting method according to a first exemplary embodiment will be described with reference to the accompanying drawings. The first exemplary embodiment assists a customer's (user's) act of purchasing a brick-and-mortar commodity (a real, physically present commodity) while viewing the physical commodity.

System Configuration

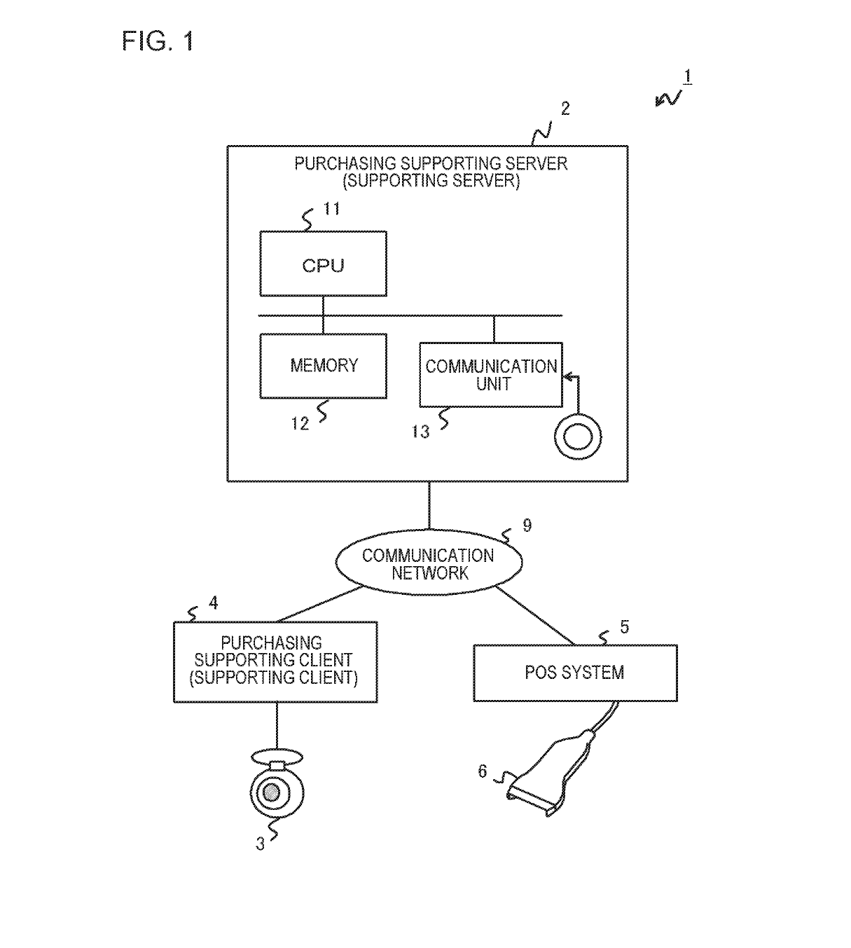

FIG. 1 is a schematic diagram showing a system configuration of a purchase assisting system 1 according to the first exemplary embodiment. Hereinafter, the purchase assisting system 1 may be simply referred to as an assist system 1. As shown in FIG. 1, the assist system 1 includes a purchase assisting server (hereinafter, may be simply referred to as an assist server) 2, a first image sensor 3, a purchase assist client (hereinafter, may be simply referred to as an assist client) 4, a Point Of Sale (POS) system 5, a second image sensor 6, and the like.

The assist server 2, which is a so-called computer, includes a Central Processing Unit (CPU) 11, a memory 12, a communication unit 13, and the like which are connected to each other through a bus, as shown in FIG. 1. The memory 12 is a Random Access Memory (RAM), a Read Only Memory (ROM), a hard disk, or the like. The communication unit 13 communicates with another computer through a communication network 9 and exchanges a signal with another device. A portable recording medium or the like may be connected to the communication unit 13. The assist server 2 may include a hardware element not shown in FIG. 1, and a hardware configuration of the assist server 2 is not limited.

The assist server 2 is communicably connected to an assist client 4 and a POS system 5 through a communication network 9. The communication network 9 is formed by a combination of a Wireless Fidelity (Wi-Fi) line network, an Internet communication network, a dedicated line network, a Local Area Network (LAN), and the like. However, in this exemplary embodiment, a communication mode between the assist server 2, the assist client 4, and the POS system 5 is not limited.

The first image sensor 3 is a visible light camera that acquires an image from which an object that can be carried by a user (also referred to as a portable object) and a user identification symbol which is included in the portable object can be identified. The portable object and the user identification symbol will be described later. The first image sensor 3 is installed at a position and in a direction which allow an image of at least one commodity to be captured. For example, the first image sensor 3 is fixedly installed at a position above the commodity in a direction facing the commodity. In FIG. 1, one first image sensor 3 is shown, but the number of first image sensors 3 is not limited.

The assist client 4 is a device that transmits an image obtained from the first image sensor 3 to the assist server 2 through the communication network 9. The assist client 4 may also function as a hub of the plurality of first image sensors 3. In addition, the assist client 4 may check the operation of the first image sensor 3 and may perform abnormality diagnosis, and the like. The assist client 4 has a well-known hardware configuration (not shown) which is capable of achieving such a well-known function.

The second image sensor 6 is a sensor device that acquires sensor information allowing to identify a user identification symbol included in a portable object. For example, the second image sensor 6 is a visible light camera. In addition, in a case where the user identification symbol is a bar code or a two-dimensional code, the second image sensor 6 may be a laser sensor. In a case where the user identification symbol has a specific shape, the second image sensor 6 may be a displacement meter that measures a shape.

The POS system 5 includes at least one second image sensor 6. For example, each POS terminal included in the POS system 5 includes the second image sensor 6. The POS system 5 transmits sensor information acquired from the second image sensor 6 to the assist server 2 through the communication network 9. In addition, the POS system 5 receives purchasing target information from the assist server 2 and performs a general accounting process and a POS process based on the purchasing target information. A specific configuration of the POS system 5 is not limited.

Processing Configuration

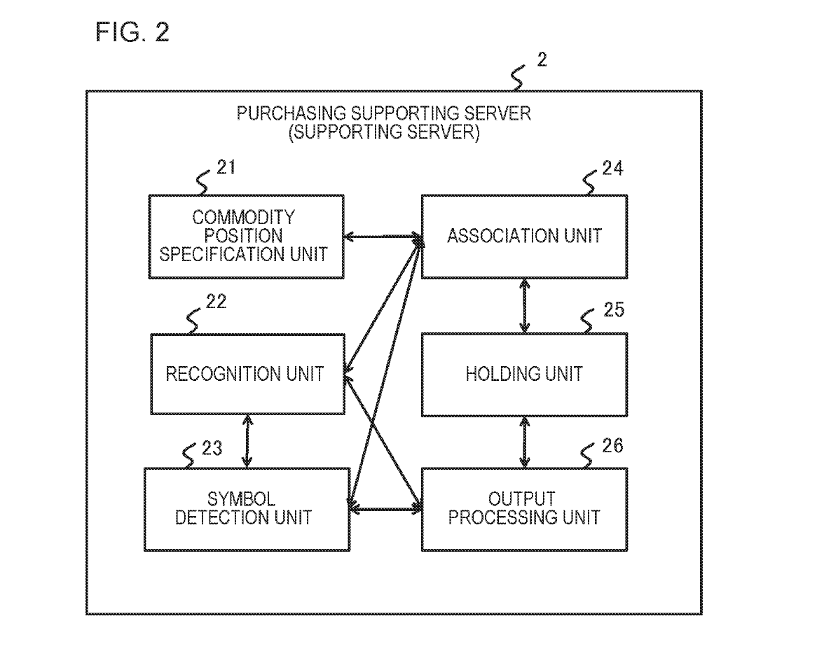

FIG. 2 is a schematic diagram showing a processing configuration example of the assist server 2 according to the first exemplary embodiment. The assist server 2 includes a commodity position specification unit 21, a recognition unit 22, a symbol detection unit 23, an association unit 24, a retaining unit 25, an output processing unit 26, and the like. These processing units are achieved, for example, by executing programs stored in the memory 12 by the CPU 11. In addition, the programs may be installed from a portable recording medium, such as a Compact Disc (CD) or a memory card, or another computer on a network through the communication unit 13, and may be stored in the memory 12.

The commodity position specification unit 21 specifies the position of a commodity in an image obtained from the first image sensor 3. There are a plurality of methods of specifying the position of a commodity. For example, the commodity position specification unit 21 detects a commodity by performing image recognition on the image and specifies the position of an image region indicating the commodity in the image. The commodity position specification unit 21 can detect a commodity identification symbol such as a bar code in the image and specify the detected position of the commodity identification symbol as the position of the commodity. In addition, in a case where an imaging direction of the first image sensor 3 is fixed, the commodity position specification unit 21 may retain the position of a commodity in the image in advance and use the held positional information. The commodity position specification unit 21 can also specify the position of a plurality of commodities in the image.

The recognition unit 22 recognizes a portable object in an image obtained from the first image sensor 3 using the image, and specifies the position of the recognized portable object in the image. For example, the recognition unit 22 scans the image using a feature amount of the portable object which is stored in the assist server 2 or another computer in advance, to thereby recognize an image region having a feature amount equal to or greater than a predetermined degree of similarity as a portable object. However, any image recognition technique can be used for the recognition of a portable object which is performed by the recognition unit 22. The portable object which is recognized has a user identification symbol and may be any object insofar as the object can be carried by a person.

The portable object may have a user identification symbol in various modes. For example, the user identification symbol is printed on or attached to the portable object. In addition, the user identification symbol may be engraved in or handwritten on the portable object. Further, the user identification symbol may be a shape of at least a portion of the portable object. The wording “user identification symbol” as used herein refers to a shape with which a user can be recognized. The user identification symbol is, for example, a character string symbol (character string itself) which indicates a user ID, a bar code and a two-dimensional code that are obtained by encoding a user ID, a predetermined image or a predetermined shape which is determined for each user, or the like. That is, the user identification symbol is a character, a figure, a sign, a stereoscopic shape, a color, or a combination thereof.

The symbol detection unit 23 detects a user identification symbol included in a portable object which is recognized by the recognition unit 22 from an image obtained from the first image sensor 3 using the image. The detection of the user identification symbol can be achieved by the same method as the above-mentioned method of recognizing a portable object. Any image recognition method can be used for the detection of the user identification symbol which is performed by the symbol detection unit 23. In order to improve detection speed, the symbol detection unit 23 can use the position of a portable object specified by the recognition unit 22.

The symbol detection unit 23 can also detect an operation symbol indicating cancellation, the operation symbol further included in the portable object in addition to the user identification symbol. In this case, the portable object has the operation symbol in such a mode that an input operation and a cancel operation can be discriminated from each other depending on the viewing direction. For example, the portable object has a direction in which only a user identification symbol can be visually perceived and an operation symbol indicating cancellation cannot be visually perceived, and a direction in which both a user identification symbol and an operation symbol indicating cancellation can be visually perceived. In addition, the portable object may further include an operation symbol indicating an input in addition to an operation symbol indicating cancellation. In this case, the portable object has a direction in which both a user identification symbol and an operation symbol indicating an input can be visually perceived and a direction in which both a user identification symbol and an operation symbol indicating cancellation can be visually perceived.

The wording “operation symbol” as used herein refers to a shape allowing to specify a cancel operation or an input operation. The operation symbol is, for example, a character string symbol (character string itself) indicating a cancel operation or an input operation, a bar code and a two-dimensional code that are obtained by encoding an operation ID allowing to specify the operation, a predetermined image or a predetermined shape which is determined for each operation, or the like. The portable object may include an operation symbol in various modes that are the same as those of the user identification symbol.

The association unit 24 associates user identification information obtained using a user identification symbol detected by the symbol detection unit 23 with information on a commodity, in accordance with a relationship between the position of the commodity which is specified by the commodity position specification unit 21 and the position of a portable object which is specified by the recognition unit 22. A positional relationship between the commodity and the portable object which serves as a condition for performing the association may be set so as to represent a user's intention of setting the commodity as a candidate to be purchased, and a specific positional relationship serving as the condition is not limited. For example, the association unit 24 performs the association in a case where the commodity and the portable object overlap each other, even if partially, in an image. In addition, the association unit 24 may perform the association in a case where a region in which the commodity and the portable object overlap each other in the image is equal to or larger than a predetermined region. The association unit 24 sets a center point for each image region indicating a commodity and an image region indicating a portable object, and can also perform the association in a case where a distance between the center points is equal to or less than a predetermined distance.

There are a plurality of methods of obtaining user identification information using a user identification symbol. In a case where the user identification symbol is a character string symbol, the association unit 24 acquires user identification information from the user identification symbol using, for example, a well-known Optical Character Recognition (OCR) technique. In a case where the user identification symbol is a bar code or a two-dimensional code, the association unit 24 decodes the user identification symbol to thereby acquire user identification information. In a case where the user identification symbol is a predetermined image or a predetermined shape, the association unit 24 performs an image matching process or a shape matching process using information associated with a predetermined image or a predetermined shape for each piece of user identification information which is stored in the assist server 2 or another computer in advance. The association unit 24 acquires user identification information based on results of the matching process.

Specific contents of commodity information associated with a user identification symbol are not limited insofar as the information allows the commodity to be paid at the POS system 5. It is preferable that the commodity information is information such as a commodity ID, for example, a Price LookUp (PLU) code, or a commodity name allowing to identify the commodity.

There are a plurality of methods of acquiring information on a commodity. For example, in a case where the commodity position specification unit 21 specifies the position of a commodity in an image through image recognition, information is used in which a feature amount used for the image recognition is associated with a commodity ID for identifying the commodity for each commodity. The association unit 24 extracts an ID of a commodity having a predetermined positional relationship with respect to a portable object from the association information, to thereby acquire the commodity ID as the commodity information. The above-mentioned association information may be retained in the assist server 2, or may be acquired from another computer such as a server device included in the POS system 5.

In addition, in a case where the commodity position specification unit 21 specifies the position of a commodity in an image using a bar code, a two-dimensional code, and a commodity identification symbol such as a character string indicating a commodity name, the association unit 24 can also acquire commodity information from the commodity identification symbol detected by the commodity position specification unit 21. In addition, in a case where the commodity position specification unit 21 retains in advance association information between the position of a commodity in an image which is obtained by the first image sensor 3 and information on the commodity, the association unit 24 may also extract the information on the commodity having a predetermined positional relationship with respect to a portable object from the association information, to thereby acquire the commodity information.

The association unit 24 can perform association between user identification information and commodity information and can cancel the association as follows in a case where a portable object includes the above-mentioned operation symbol. For example, the association unit 24 performs association based on the above-mentioned positional relationship between the portable object and the commodity in a case where only a user identification symbol is detected and an operation symbol indicating cancellation is not detected by the symbol detection unit 23. In addition, the association unit 24 performs association based on the above-mentioned positional relationship between the portable object and the commodity in a case where a user identification symbol and an operation symbol indicating an input are detected by the symbol detection unit 23.

On the other hand, the association unit 24 cancels the existing association as follows in a case where a user identification symbol and an operation symbol indicating cancellation are detected by the symbol detection unit 23. The association unit 24 specifies a commodity having a predetermined positional relationship with respect to a detection position of the operation symbol or the position of a portable object including the operation symbol, and cancels the existing association between information on the specified commodity and user identification information obtained using a user identification symbol detected by the symbol detection unit 23. For example, the association unit 24 deletes the existing association which is held by the retaining unit 25. The association unit 24 can also set a cancel flag in the existing association which is held by the retaining unit 25.

The retaining unit 25 retains a combination of user identification information and commodity information that are associated with each other by the association unit 24.

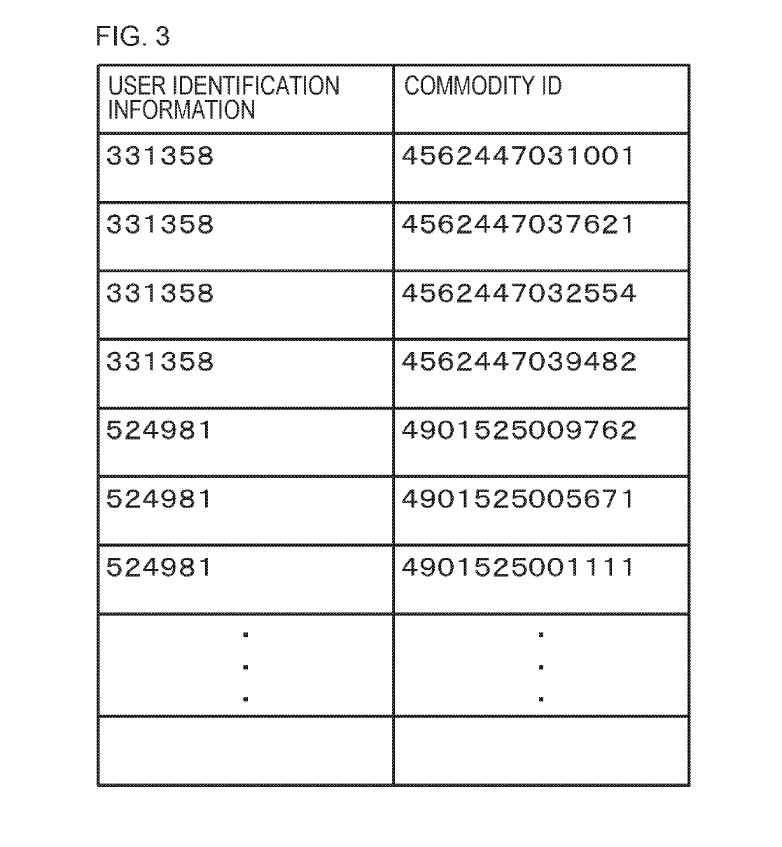

FIG. 3 is a diagram showing an example of association information which is held by the retaining unit 25. In the example of FIG. 3, a numerical string is set as user identification information, and a commodity ID is set as commodity information. In the example of FIG. 3, four commodity IDs are associated with user identification information “331358”.

The output processing unit 26 acquires user identification information, specifies commodity information associated with the acquired user identification information in the retaining unit 25, and outputs purchasing target information including the specified commodity information. The output processing unit 26 receives sensor information transmitted from the POS system 5, and acquires user identification information from the sensor information.

In a case where sensor information is an image, the recognition unit 22 mentioned above recognizes a portable object from the image, the symbol detection unit 23 mentioned above detects a user identification symbol from the image, and the output processing unit 26 acquires user identification information from the detected user identification symbol. The same method as that of the association unit 24 may be used as a method of acquiring user identification information from a user identification symbol. In a case where the second image sensor 6 is a laser sensor, the output processing unit 26 decodes a bar code or a two-dimensional code which is indicated by the sensor information, to thereby acquire user identification information. In addition, in a case where sensor information is shape information, the output processing unit 26 acquires user identification information corresponding to the shape.

A mode in which purchasing target information is output is not limited. The output mode includes, for example, transmitting the information, saving as a file, displaying, printing, and the like. For example, the output processing unit 26 transmits the specified commodity information and the user identification information to the POS system 5 as purchasing target information. In this case, the POS system 5 performs a general accounting process and POS process based on the purchasing target information. As another example, the output processing unit 26 can also transmit the purchasing target information to an on-line settlement system. In this case, in the on-line settlement system, a settlement process is performed based on the purchasing target information.

### Operation Example/Purchase Assisting Method

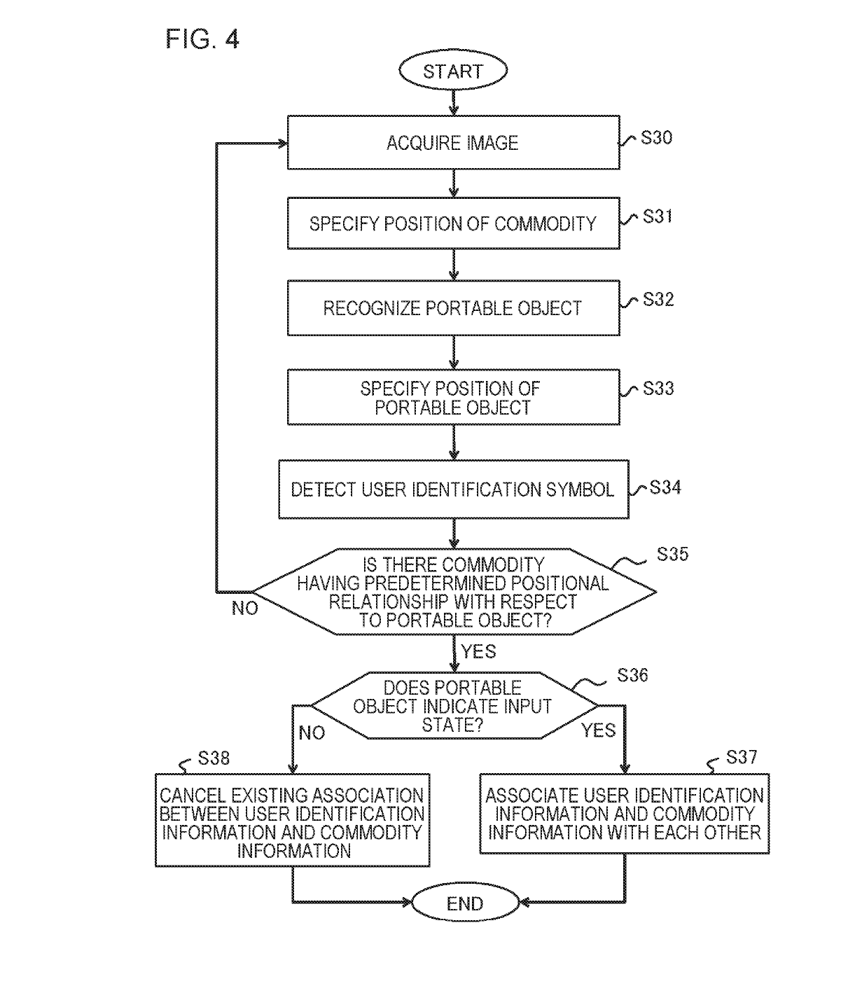

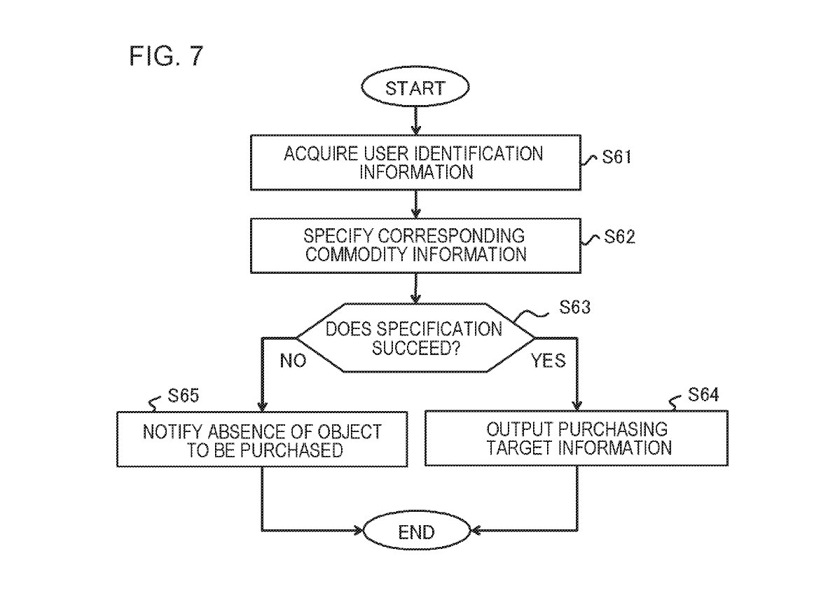

Hereinafter, the purchase assisting method according to the first exemplary embodiment will be described with reference to FIGS. 4 and 7 based on an example of a use scene of the first exemplary embodiment which is performed by a user who is a customer. FIGS. 4 and 7 are flow charts showing an operation example of the assist server 2 according to the first exemplary embodiment. As shown in FIGS. 4 and 7, the purchase assisting method according to the first exemplary embodiment is performed by at least one computer such as the assist server 2. For example, processes shown in the drawings are performed by respective processing units included in the assist server 2. The processes have processing contents that are the same as those of the above-mentioned processing units included in the assist server 2, and thus details of the processes will not be repeated.

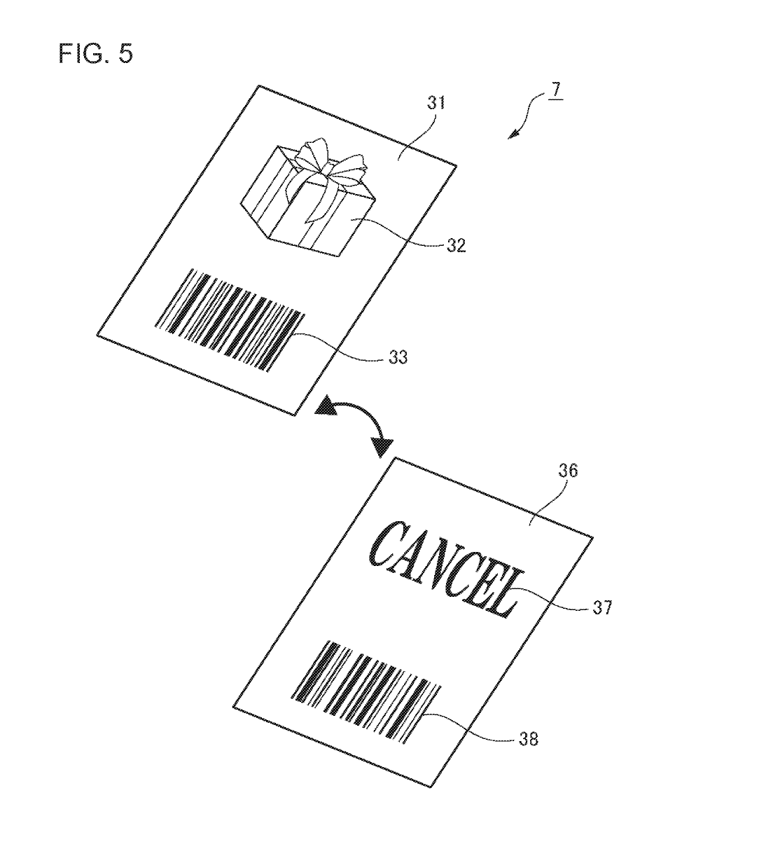

FIG. 5 is a diagram showing a specific example of a portable object. A portable object 7 shown in FIG. 5 has a card shape, an operation image 32 indicating an input and a bar code 33 are printed on a front surface 31 of the portable object, and an operation image 37 indicating cancellation and a bar code 38 are printed on a rear surface 36 of the portable object. In the example of FIG. 5, the operation images 32 and 37 are operation symbols, and the bar codes 33 and 38 are user identification symbols. The same user identification information allowing to identify one user is encoded in each of the bar codes 33 and 38.

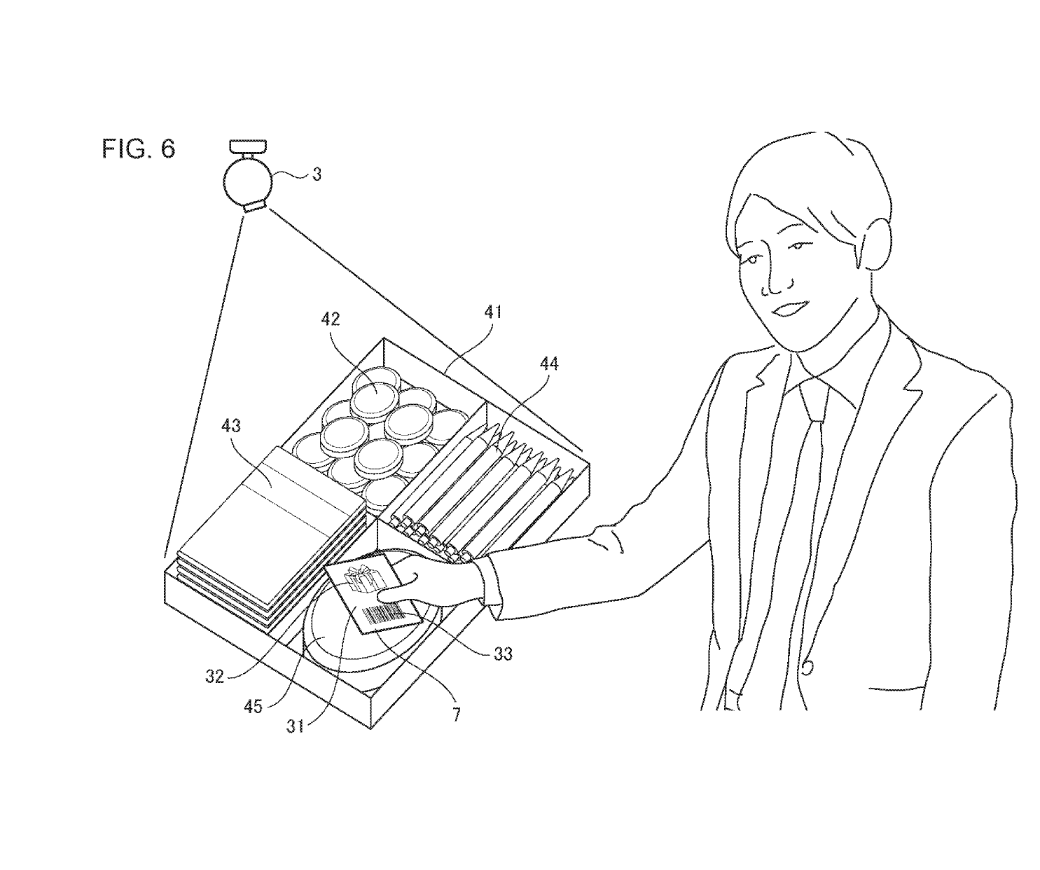

A user performs an act of purchasing a commodity using the portable object 7 including the user's own user identification symbol as shown in FIG. 5. First, the user goes to a shelf on which a desired commodity is displayed while holding the portable object 7. At this shelf, the first image sensor 3 is installed as shown in FIG. 6.

FIG. 6 is a diagram showing a specific example of a commodity display shelf. In the example of FIG. 6, the first image sensor 3 is fixedly installed on a ceiling above display shelves of four types of commodities 42, 43, 44, and 45 in a direction of imaging the display shelves. In the example of FIG. 6, the first image sensor 3 captures images of the four types of commodities, but the plurality of first image sensors 3 may be provided so as to be able to capture an image of each commodity without the captured areas overlapping with each other.

The user holds the portable object 7 over a commodity to be a candidate to be purchased so that the commodity and the portable object 7 overlap each other in an image obtained by the first image sensor 3, as shown in FIG. 6. In the example of FIG. 6, since the portable object 7 shown in FIG. 5 is used, the user holds the portable object 7 so that the front surface 31 faces the first image sensor 3. The user holds the portable object 7 over a desired commodity in this manner, and thus can add the commodity as candidates to be purchased. At this time, the assist server 2 is operated as follows.

FIG. 4 is a flow chart showing an operation example at the time of setting a candidate to be purchased in the assist server 2 according to the first exemplary embodiment. The assist server 2 sequentially acquires images to be processed from the first image sensor 3 (S30). A method of selecting an image to be processed in an image frame acquired from the first image sensor 3 is arbitrary. The selection method is determined based on, for example, a processing speed of the assist server 2.

The assist server 2 specifies the position of a commodity in an image obtained from the first image sensor 3 (S31). According to the example of FIG. 6, the assist server 2 specifies positions of each of the commodities 41, 42, 43, and 44 in an image obtained by the first image sensor 3. In the example of FIG. 6, the first image sensor 3 is fixedly installed, and thus the position of each commodity seen in the image is unchangeable except for a case where a display position is readjusted. Consequently, the assist server 2 can specify in advance the four regions for the commodities 41, 42, 43, and 44 in the image. In addition, the assist server 2 may perform image recognition on each commodity, to thereby specify the position of each commodity.

When a user holds the portable object 7 over a commodity, the assist server 2 recognizes the portable object 7 in an image acquired in (S30) (S32), and specifies the position of the recognized portable object in the image (S33).

Subsequently, the assist server 2 detects a user identification symbol from the image acquired in (S30) (S34). According to the example of FIG. 6, the assist server 2 detects a bar code 33. Using the position of the portable object specified in (S33), the assist server 2 can detect the user identification symbol in an image region indicating the portable object 7 in the image to thereby improve the detection speed.

The assist server 2 determines whether or not a commodity having a predetermined positional relationship with respect to the portable object 7 is present based on the position of the commodity which is specified in (S31) and the position of the portable object 7 which is specified in (S33) (S35). In a case where the commodity is not present (S35; NO), the assist server 2 acquires another image as an object to be processed (S30).

In a case where the commodity is present (S35; YES), the assist server 2 determines whether or not the recognized portable object 7 indicates an input state (S36). Specifically, the assist server 2 determines at least one of whether or not an operation symbol indicating an input is detected and whether or not an operation symbol indicating cancellation is detected, in accordance with the mode of the portable object 7. In the example of FIG. 6, the assist server 2 can detect an operation symbol 32 indicating an input together with a user identification symbol 33 in the image (S36; YES).

In a case where the assist server 2 determines that the portable object 7 indicates an input state (S36; YES), the assist server associates user identification information obtained using the user identification symbol detected in (S34) with information on the commodity which is determined in (S35) to have a predetermined positional relationship with respect to the portable object 7 (S37). When (S37) is performed, the commodity is added to the user's candidates to be purchased.

On the other hand, in a case where the assist server 2 determines that the portable object 7 does not indicate an input state (S36; NO), the assist server cancels the existing association between the user identification information obtained using the user identification symbol detected in (S34) and the information on the commodity which is determined in (S35) to have a predetermined positional relationship with respect to the portable object 7 (S38). For example, the assist server 2 specifies association between the user identification information and the commodity information by the retaining unit 25, and deletes the specified association.

A method of acquiring user identification information and commodity information is as described above. In the example of FIG. 6, the assist server 2 decodes the bar code 33 as the user identification symbol detected in (S34) to thereby acquire user identification information. The assist server 2 acquires information on the commodity of which the position is specified in (S31).

In this manner, according to the first exemplary embodiment, the portable object 7 of the user functions as a virtual shopping cart (hereinafter, also referred to as a virtual cart), and the user's act of holding the portable object 7 over a commodity means input to the shopping cart or the cancellation of the input. In this way, when the input of a commodity which is a candidate to be purchased to the virtual cart (portable object 7) is completed, the user takes the portable object 7 to a cash register at the time of payment. A cash register clerk reads a user identification symbol of the portable object 7 using the second image sensor 6.

FIG. 7 is a flow chart showing an operation example of the assist server 2 during payment according to the first exemplary embodiment. Sensor information acquired by the second image sensor 6 is transmitted from the POS system 5 to the assist server 2. According to the example of FIG. 6, a user identification symbol is the bar code 33, and thus the second image sensor 6 may be a visible light sensor or may be a laser sensor. In a case where the second image sensor 6 is a visible light sensor, the assist server 2 acquires an image from the POS system 5. In a case where the second image sensor 6 is a laser sensor, the assist server 2 can obtain contrast pattern information (bar code information) from the POS system 5 as sensor information.

The assist server 2 receives the sensor information and acquires user identification information from the received sensor information (S61).

The assist server 2 specifies commodity information associated with the user identification information acquired in (S61) in the retaining unit 25 (S62).

In a case where the assist server 2 succeeds in the specification of commodity information (S63; YES), the assist server outputs purchasing target information including the specified commodity information (S64). A mode in which purchasing target information is output is as described above. On the other hand, in a case where the assist server 2 fails in the specification of commodity information (S63; NO), that is, in a case where commodity information associated with the user identification information acquired in (S61) is not present in the retaining unit 25, the assist server notifies the absence of an object to be purchased (S65).

Here, in a case where the POS system 5 receives purchasing target information from the assist server 2, the POS system performs an accounting process of the purchasing target information. In a case where the absence of an object to be purchased is notified by the assist server 2, the POS system 5 displays to that effect on a POS register device. In addition, in a case where the on-line settlement system receives purchasing target information from the assist server 2, the on-line settlement system performs a settlement process of the purchasing target information. Thereby, the user can purchase a commodity that is a candidate to be purchased set using the portable object 7 functioning as a virtual cart.

In FIGS. 4 and 7, a plurality of steps (processes) are sequentially shown, but steps performed in the first exemplary embodiment and an operation order of the steps are not limited to only the examples of FIGS. 4 and 7. For example, in a case where the position of a commodity in an image which is obtained by the first image sensor 3 is fixed, (S31) is not required to be performed each time. In addition, the assist server 2 may recognize the portable object only within a region of the commodity specified in (S31) as a target (S32). In this case, when the portable object is recognized in (S32), since a commodity having a predetermined positional relationship with respect to the portable object is necessarily present, (S35) is not necessary. (S32) and (S33) may be performed before (S31). In this case, the assist server 2 may determine whether or not a commodity is present in a range in which the commodity has a predetermined positional relationship with reference to the position of the portable object which is specified in (S33) in the image.

Operations and Effects in First Exemplary Embodiment

As described above, in the first exemplary embodiment, positions of a commodity and a portable object are specified in an image obtained from the first image sensor 3, and a user identification symbol of the portable object is detected from the image. In addition, information on the commodity and user identification information obtained from the detected user identification symbol are associated with each other, and the association information is stored in the retaining unit 25. In the first exemplary embodiment, a user who is a customer holds a portable object including a user identification symbol of the user over a commodity so that the portable object is imaged by the first image sensor 3 in a predetermined positional relationship with respect to a desired commodity, thereby exhibiting such operations.

The association information between the commodity information and the user identification information which is retained in the retaining unit 25 is used as purchasing target information in the POS system 5. Thus, according to the first exemplary embodiment, the customer can set the commodity as a candidate to be purchased by only holding the portable object over the desired commodity. Thereby, the user does not need to carry the commodity around which is a candidate to be purchased in the store, and thus the burden of the act of purchasing is reduced.

That is, according to the first exemplary embodiment, it is possible to make a non-electronic portable object existing in reality to virtually have a function of an electronic cart which is used in only an EC site at the present. In this manner, the concept of causing a non-electronic portable object existing in reality to virtually have the function of the electronic cart is completely different from an ordinary thinking of using an electronic means such as an electronic cart in an EC site or a handy terminal in the proposed method mentioned above. Such a concept has been recalled by shifting from the ordinary thinking.

Further, in the first exemplary embodiment, the portable object is sensed by the second image sensor 6 of the POS system 5. User identification information is acquired based on sensor information acquired by the sensing, and commodity information stored in the retaining unit 25 is specified in association with the user identification information. Purchase object information including the specified commodity information is transmitted to the POS system 5, and an accounting process is performed in a POS register device using the purchasing target information. Thereby, by inputting commodities which are candidates to be purchased into a virtual cart (portable object) as described above, and then handing the portable object to a cash register clerk, the user can actually purchase the candidate commodities to be purchased. On the other hand, the cash register clerk may perform only an operation of causing the second image sensor 6 to read a user identification symbol of the portable object without performing a conventional operation of registering individual commodities carried to the cash register to be checked out. Accordingly, a store can obtained an advantage in that the efficiency of an accounting operation can be improved. An improvement in the efficiency of an accounting operation reduces the customer's time spent in line at the cash register, and thus it is possible to reduce the burden of a user's act of purchasing also in this respect.

In addition, in the first exemplary embodiment, in a case where an operation symbol indicating cancellation is detected together with a user identification symbol, the existing association between information on a commodity having a predetermined positional relationship with respect to a portable object and user identification information obtained using the detected user identification symbol is canceled. In this manner, by the portable object having an operation symbol, it is possible to separate an operation of inputting a commodity to a virtual cart from an operation of canceling a commodity in the virtual cart. In a case where a user desires to exclude a commodity which has been inputted into the virtual cart from candidates to be purchased, the user may just hold a portable object over the commodity so that an operation symbol indicating cancellation and a user identification symbol are imaged by the first image sensor 3 together with the commodity. In this manner, according to the first exemplary embodiment, the user can perform setting of a commodity as a candidate to be purchased and exclusion of a commodity from a candidate to be purchased by only changing the way of holding the portable object over a commodity.

According to the first exemplary embodiment, an IC tag attached for each commodity or a handy terminal for a customer are not necessary in order to obtain such operations and effects. Providing each customer with a portable object including a user identification symbol is sufficient. Thereby, according to the first exemplary embodiment, it is possible to reduce introduction and operation costs for the store.

Supplement to First Exemplary Embodiment

In the above description, an example has been described in which a “commodity” which is imaged in an image obtained from the first image sensor 3 is a brick-and-mortar commodity (a real, physically existing commodity), but the “commodity” may be a substitute indicating a physical commodity. The substitute may indicate the physical commodity in any form and is, for example, a photo in which the physical commodity is imaged, a name card on which the name or description of the physical commodity is printed, a model of the physical commodity, only the packing container of the commodity, only the packing box of the commodity, or the like. In this case, a portable object of a user is held over a substitute of a certain commodity by the user in order to set the commodity as an object to be purchased. The assist server 2 (association unit 24) associates user identification information obtained using a user identification symbol detected by the symbol detection unit 23 with information on a commodity which is indicated by a substitute in accordance with a relationship between the position of the substitute of the commodity specified by the commodity position specification unit 21 and the position of a portable object specified by the recognition unit 22.

### Second Exemplary Embodiment

Hereinafter, a purchase assisting system and a purchase assisting method according to a second exemplary embodiment will be described with reference to a plurality of drawings. The second exemplary embodiment supports an act of a customer (user) purchasing a physical commodity or an electronic commodity while viewing a commodity symbol corresponding to the physical commodity or the electronic commodity. The electronic commodity is an electronic book, an electronic game, an application, or the like which is used on a user terminal. Hereinafter, the second exemplary embodiment will be described focusing on contents different from those in the first exemplary embodiment, and the same contents as in the first exemplary embodiment will not be repeated.

System Configuration

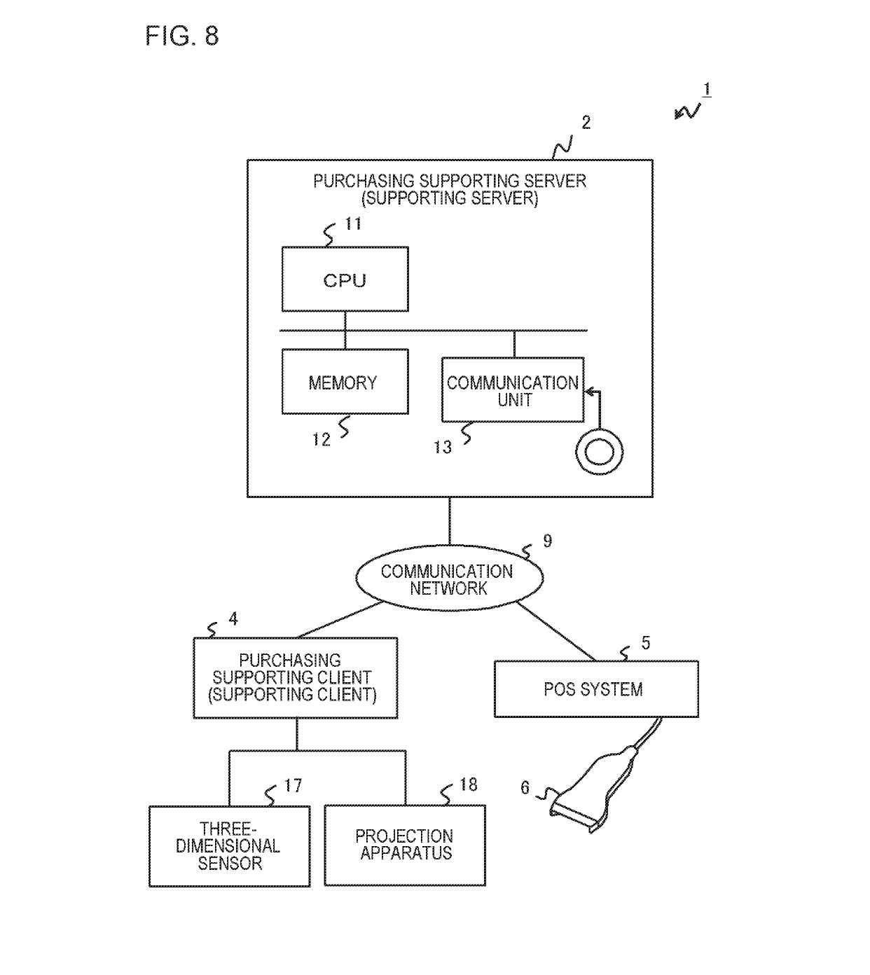

FIG. 8 is a schematic diagram showing a system configuration of a purchase assisting system 1 according to the second exemplary embodiment. As shown in FIG. 8, the assist system 1 according to the second exemplary embodiment includes a three-dimensional sensor 17 and a projection apparatus 18 instead of a first image sensor 3.

An assist client 4 is a device that transmits sensor information obtained from the three-dimensional sensor 17 to the assist server 2 through a communication network 9, receives image information from the assist server 2 through the communication network 9, and transmits the image information to the projection apparatus 18. The assist client 4 may function as a hub of the plurality of three-dimensional sensors 17 and the plurality of projection apparatuses 18. In addition, the assist client 4 may confirm the operation of the three-dimensional sensor 17 and the projection apparatus 18 and may perform abnormality diagnosis, and the like. The assist client 4 has a well-known hardware configuration (not shown) which is capable of achieving such a well-known function.

The three-dimensional sensor 17 acquires sensor information including information on a two-dimensional image and information (depth information) regarding a distance from the three-dimensional sensor 17. The three-dimensional sensor 17 is achieved by, for example, a visible light camera and a distance image sensor. The distance image sensor is also referred to as a depth sensor and irradiates a near-infrared light pattern with a laser, and a distance (depth) between the distance image sensor and an object to be detected is calculated based on information obtained by imaging the pattern by a camera that detects near-infrared light. However, a method of achieving the three-dimensional sensor 17 is not limited. The three-dimensional sensor 17 may be achieved by a three-dimensional scanning method using a plurality of cameras.

The projection apparatus 18 projects light onto a projection surface based on image information transmitted from the assist server 2, to thereby project any image on the projection surface. In the second exemplary embodiment, the projection apparatus 18 projects a commodity symbol onto a projection surface. Here, the commodity symbol means a commodity image indicating a physical commodity or an electronic commodity or means a character, a figure, a sign, a color, or a combination thereof indicating the commodity. The projection apparatus 18 may include a unit that adjusts a projection direction. The unit adjusting a projection direction includes a mechanism that changes the orientation of a project ion unit that projects light, a mechanism that changes a direction of light projected from the projection unit, and the like.

Processing Configuration

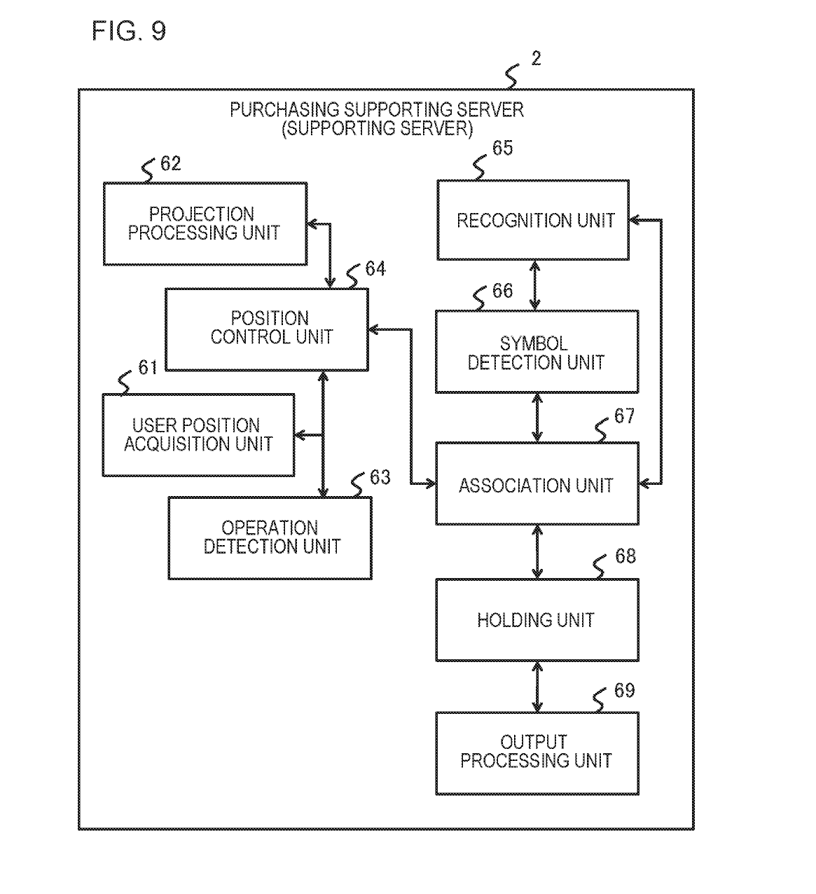

FIG. 9 is a schematic diagram showing a processing configuration example of the assist server 2 according to the second exemplary embodiment. The assist server 2 includes a user position acquisition unit 61, a projection processing unit 62, an operation detection unit 63, a position control unit 64, a recognition unit 65, a symbol detection unit 66, an association unit 67, a retaining unit 68, an output processing unit 69, and the like. These processing units are achieved, for example, by executing programs stored in a memory 12 by a CPU 11. In addition, the programs may be installed from a portable recording medium, such as a Compact Disc (CD) or a memory card, or another computer on a network through a communication unit 13, and may be stored in the memory 12.

The user position acquisition unit 61 recognizes a specific body part of a user based on sensor information obtained from the three-dimensional sensor 17 and acquires positional information of the recognized specific body part. Specifically, the user position acquisition unit 61 recognizes the user's specific body part using at least one of image information and depth information that are included in the sensor information. The recognized specific body part is a portion of the body (fingertip or the like) or an operation tool used when the user performs an operation. A well-known object recognition method may be used as a method of recognizing the specific body part from an image. As an example of a recognition method, the user position acquisition unit 61 recognizes the head of a person using a feature amount from image information, and the specific body part is recognized from a positional relationship with respect to the person's head and the feature amount using image information and distance information.

The user position acquisition unit 61 acquires positional information of the user's specific body part which is recognized as described above, based on two-dimensional image information and distance information that are included in the sensor information. For example, the user position acquisition unit 61 can acquire positional information of the specific body part in a three-dimensional coordinate space which is set based on the position and orientation of the three-dimensional sensor 17.

The projection processing unit 62 causes the projection apparatus 18 to project a commodity symbol. Specifically, the projection processing unit 62 transmits image information of the commodity symbol to the projection apparatus 18 through the assist client 4, to thereby make the projection apparatus 18 project the commodity symbol based on the image information. The image information may indicate a plurality of commodity symbols, and is acquired from the assist server 2 or another computer.

The operation detection unit 63 detects a user's operation using a user's specific body part with respect to a commodity symbol by using positional information of the commodity symbol and positional information of the specific body part which is acquired by the user position acquisition unit 61. For example, the operation detection unit 63 can acquire positional information of a commodity symbol as follows. The operation detection unit 63 can recognize a distance (projection distance) between the projection apparatus 18 and a projection surface based on the position and projection direction of the projection apparatus 18 and sensor information, and can specify a position where a projection screen is projected in the above-mentioned three-dimensional coordinate space based on projection specifications of the distance and projection apparatus 18. The wording “projection screen” as used herein refers to the entire image which is projected onto a projection surface by the projection apparatus 18.

In a case where the position of a commodity symbol is changed by only a projection direction of the projection apparatus 18, the operation detection unit 63 can use the position of a projection screen which is specified as described above as a position at which the commodity symbol is projected. In addition, in a case where a projection direction of the projection apparatus 18 is fixed or in a case where the projection direction is variable and the position of a commodity symbol is variable in a projection screen, the operation detection unit 63 can obtain information on the position of the commodity symbol in the above-mentioned three-dimensional coordinate space based on the position of the projection screen which is specified as described above and the position of the commodity symbol in the projection screen which is obtained from image information processed by the projection processing unit 62.

The operation detection unit 63 detects a user's operation based on a positional relationship between a commodity symbol and a user's specific body part which is mapped on a common three-dimensional coordinate space as described above. For example, the operation detection unit 63 detects a contact between the commodity symbol and the user's specific body part as the user's operation.

The position control unit 64 changes a position at which a commodity symbol is projected, in accordance with the user's operation which is detected by the operation detection unit 63. Specifically, the position control unit 64 can change a position at which a commodity symbol is projected, by any one or both of a change in a projection direction of the projection apparatus 18 and a change in the position of the commodity symbol in a projection screen projected by the projection apparatus 18. In a case where the position of the commodity symbol in the projection screen is changed by the position control unit 64, image information of the commodity symbol which is transmitted by the projection processing unit 62 includes information on the changed position of the commodity symbol in the projection screen.

For example, in a case where the user's operation moving on a projection surface is detected in a state where the user's specific body part is in contact with the commodity symbol, the position control unit 64 moves the commodity symbol onto the projection surface together with the specific body part. However, specific contents of a user's operation for changing the position of the commodity symbol are arbitrary.

The recognition unit 65 recognizes a portable object based on sensor information obtained from the three-dimensional sensor 17, and specifies the position of the recognized portable object on the above-mentioned three-dimensional coordinate space. The definition of a portable object and a method of recognizing the portable object are as described in the first exemplary embodiment. A portable object in the second exemplary embodiment is disposed on a projection surface of a commodity information symbol.

The symbol detection unit 66 detects a user identification symbol using sensor information obtained from the three-dimensional sensor 17. Specifically, the symbol detection unit 66 detects the user identification symbol using an image included in the sensor information. The definition of a user identification symbol and a method of detecting the user identification symbol are as described in the first exemplary embodiment.

The association unit 67 associates user identification information obtained using a user identification symbol detected by the symbol detection unit 66 with information on a commodity (a physical commodity or an electronic commodity) which corresponds to a commodity symbol, in accordance with a relationship between the position of a portable object which is recognized by the recognition unit 65 and the position of the commodity symbol changed by the position control unit 64. A positional relationship between the commodity symbol and the portable object which serves as a condition for performing the association may be set so as to represent a user's intention of setting the commodity corresponding to the commodity symbol as a candidate to be purchased, and a specific positional relationship serving as the condition is not limited. For example, the association unit 67 performs the association in a case where the commodity symbol and the portable object overlap each other, even if partially. In addition, the association unit 67 may perform the association in a case where a region in which the commodity symbol and the portable object overlap each other is equal to or larger than a predetermined region.

A method of obtaining user identification information using a user identification symbol is as described in the first exemplary embodiment. In addition, the definition of commodity information is as described in the first exemplary embodiment. In the second exemplary embodiment, commodity information may be acquired as follows. For example, the association unit 67 may acquire commodity information corresponding to a commodity symbol which is a target for a user's operation, from information in which a commodity symbol and commodity information are associated with each other. The association information may be retained in the assist server 2, or may be acquired from another computer.

The retaining unit 68 is the same as the retaining unit 25 according to the first exemplary embodiment.

The output processing unit 69 performs the same process as that of the output processing unit 26 according to the first exemplary embodiment. Further, the output processing unit 69 enables a user to acquire a commodity when payment at the cash register or on-line settlement of the commodity is completed based on the output purchasing target information of the commodity. For example, in a case where the target commodity is a physical commodity, the output processing unit 69 transmits commodity acquisition information including commodity information with which the target commodity can be specified to a corresponding system such as a stock management system or a delivery system so that the user can acquire the physical commodity at a cash register or the user's home.

In a case where the target commodity is an electronic commodity, the output processing unit 69 further outputs commodity acquisition information including site information for allowing a user to download the electronic commodity together with the specified commodity information. The site information may also be retained in association with a commodity symbol together with the commodity information. In this case, the output processing unit 69 also transmits commodity acquisition information to a POS system 5 in addition to purchasing target information. The POS system 5 issues a ticket on which the site information is printed, based on the commodity acquisition information.

### Operation Example/Purchase Assisting Method

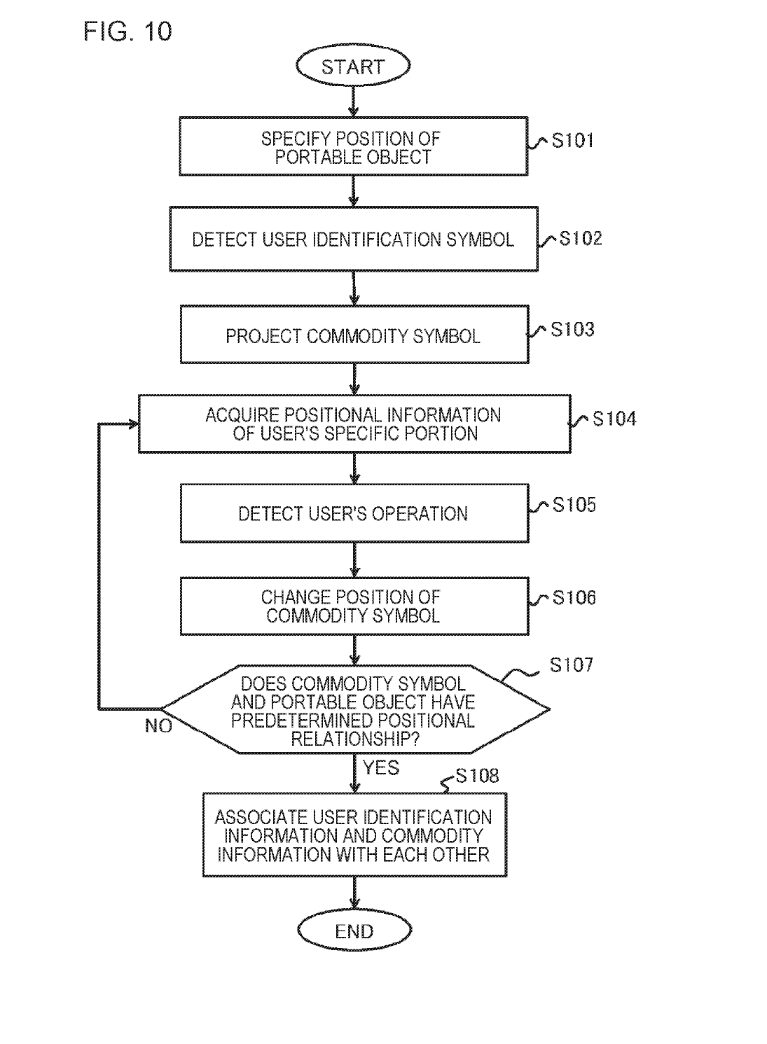

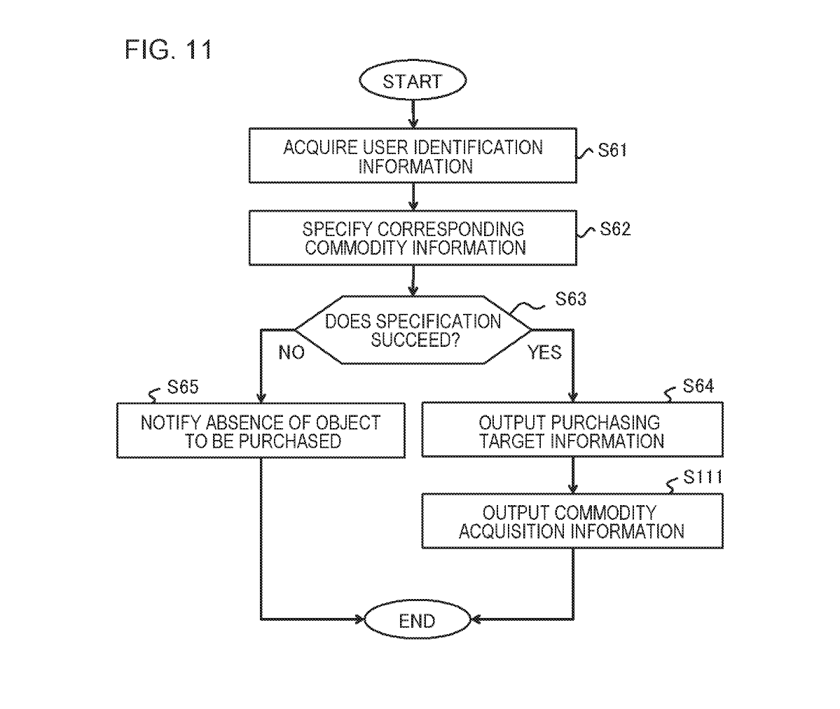

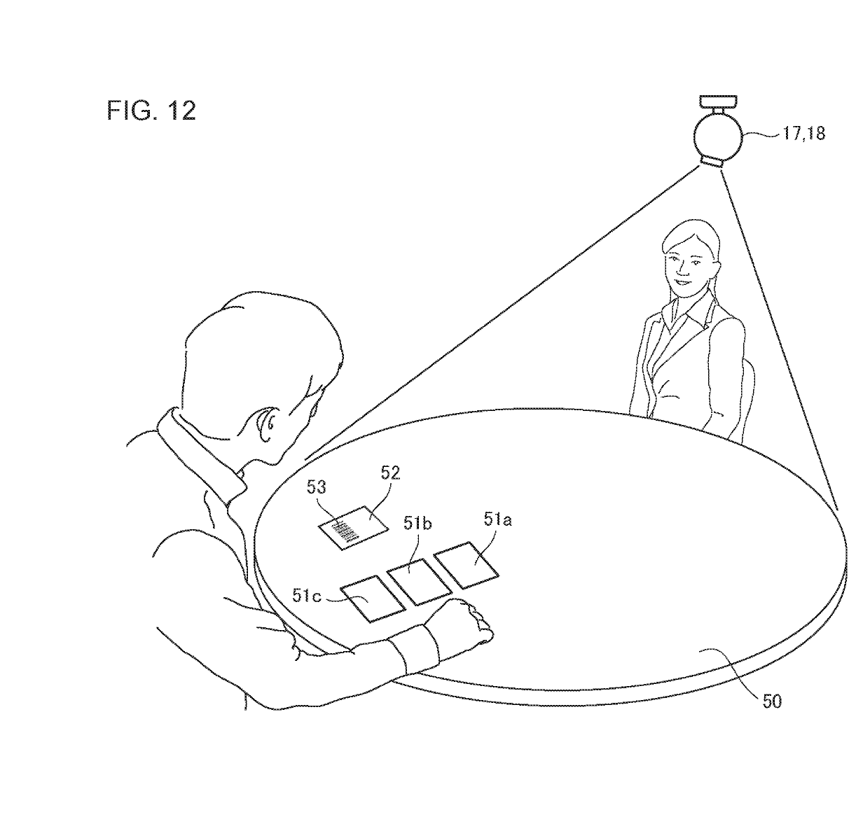

Hereinafter, a purchase assisting method according to the second exemplary embodiment will be described with reference to FIGS. 10 and 11 based on an example of a use scene of the second exemplary embodiment which is performed by a user who is a customer. FIGS. 10 and 11 are flow charts showing an operation example of the assist server 2 according to the second exemplary embodiment. As shown in FIGS. 11 and 12, the purchase assisting method according to the second exemplary embodiment is performed by at least one computer such as the assist server 2. For example, processes shown in the drawings are performed by respective processing units included in the assist server 2. The processes have processing contents that are the same as those of the above-mentioned processing units included in the assist server 2, and thus details of the processes will not be repeated.

FIG. 12 is a schematic diagram showing an example of an operation scene according to the second exemplary embodiment. In the example of FIG. 12, the entire upper surface of a table 50 is used as a projection surface, and the three-dimensional sensor 17 and the projection apparatus 18 are fixedly installed above the table 50 with the direction of the table 50 as a sensing direction and a projection direction. In addition, a portable object 52 having a card shape is disposed on the upper surface of the table 50 serving as the projection surface, and a bar code 53 as a user identification symbol is printed on the portable object 52. At this time, the assist server 2 is operated as follows.

FIG. 10 is a flow chart showing an operation example at the time of setting a candidate to be purchased in the assist server 2 according to the second exemplary embodiment. As a premise of an operation flow shown in FIG. 10, the assist server 2 sequentially acquires pieces of sensor information from the three-dimensional sensor 17.

The assist server 2 recognizes the portable object 52 based on the acquired sensor information, and specifies the position of the recognized portable object 52 (S101). The specified position of the portable object 52 is represented by a three-dimensional coordinate space which is shared by the assist server 2.

The assist server 2 detects a user identification symbol using acquired sensor information (S102). According to the example of FIG. 12, the assist server 2 detects the bar code 53. The assist server 2 can detect a user identification symbol with respect to an image region indicating the portable object 52 in a two-dimensional image included in the sensor information by using the position of the portable object 52 which is specified in (S101), to thereby improve the detection speed.

Further, the assist server 2 causes the projection apparatus 18 to project a commodity symbol (S103). Specifically, by transmitting image information of the commodity symbol to the projection apparatus 18, the assist server 2 makes the projection apparatus 18 project the commodity symbol onto a projection surface. In the example of FIG. 12, the projection screen is the entire upper surface of the table 50, and the projection apparatus 18 projects commodity symbols 51a, 51b, and 51c at positions close to the user within the projection screen. Each of the commodity symbols may be a symbol indicating a physical commodity, or may be a symbol indicating an electronic commodity. In addition, a symbol indicating a physical commodity and a symbol indicating an electronic commodity may be jointly present.

The assist server 2 recognizes a user's specific body part based on acquired sensor information, and acquires positional information of the recognized specific body part (S104). The position of the specific body part is indicated by a three-dimensional coordinate space which is shared by the assist server 2.

The assist server 2 detects a user's operation using the specific body part with respect to a commodity symbol by using positional information of the commodity symbol projected in (S103) and positional information of the user's specific body part acquired in (S104) (S105). In the example of FIG. 12, the assist server 2 detects a user's operation, using the user's specific body part, of contacting at least one of the commodity symbols 51a, 51b, and 51c and moving on the table 50 (projection surface) in the contact state.

The assist server 2 changes the position of the commodity symbol on the projection surface in accordance with the user's operation detected in (S105) (S106). There may be a plurality of methods of changing the position of a commodity symbol as described above. In the example of FIG. 12, since a projection direction of the projection apparatus 18 is fixed, the assist server 2 changes the position of a commodity symbol in a projection screen and transmits image information in which the position of the commodity symbol is changed to the projection apparatus 18, to thereby change the position of the commodity symbol on the projection surface.

The assist server 2 determines whether or not a positional relationship between the portable object specified in (S101) and the commodity symbol changed in (S106) indicates a predetermined positional relationship (S107). The assist server 2 repeats (S104) and the subsequent steps in a case where the positional relationship does not indicate the predetermined positional relationship (S107; NO).

On the other hand, in a case where the positional relationship between the portable object and the commodity symbol indicates the predetermined positional relationship (S107; YES), the assist server 2 associates user identification information obtained using the user identification symbol detected in (S102) with commodity information corresponding to the commodity symbol having a predetermined positional relationship with respect to the portable object by the position of the commodity symbol being changed in (S106) (S108). When (S108) is performed, a commodity corresponding to the commodity symbol of which the position is changed by the user's operation so as to have a predetermined positional relationship with respect to the portable object is added to the user's candidate to be purchased.

A method of acquiring user identification information and commodity information is as described above. In the example of FIG. 12, the assist server 2 decodes the bar code 53 as the user identification symbol detected in (S102) to thereby acquire user identification information. The assist server 2 acquires commodity information corresponding to the commodity symbol having a predetermined positional relationship with respect to the portable object 52.

In this manner, according to the second exemplary embodiment, the portable object 52 disposed on the projection surface by a user functions as a virtual cart, and the user's operation of moving a commodity symbol so that the portable object 52 and the commodity symbol have a predetermined positional relationship means input to a shopping cart. In this way, when the input of a commodity symbol corresponding to a commodity which is a candidate to be purchased to the virtual cart (portable object 52) is completed, the user brings the portable object 52 to a cash register at the time of payment. The cash register clerk reads the user identification symbol of the portable object 52 using a second image sensor 6.

FIG. 11 is a flow chart showing an operation example of the assist server 2 during payment according to the second exemplary embodiment. In FIG. 11, processes having the same contents as those of the processes shown in FIG. 7 are denoted by the same reference numerals and signs as in FIG. 7. That is, in the second exemplary embodiment, the assist server 2 further performs (S111) in addition to the processes shown in FIG. 7.

When the purchasing target information is output in (S64), the assist server 2 outputs commodity acquisition information of the commodity (S111). In addition, (S111) may be performed simultaneously with (S64), or may be performed before the operation of (S64). In addition, the assist server 2 may perform (S111) after payment at the cash register or on-line settlement of a commodity has been completed based on the purchasing target information. The completion of the payment is notified from, for example, the POS system 5, and the completion of the on-line settlement is notified from, for example, an on-line settlement system.

In a case where a target commodity is a physical commodity, the assist server 2 transmits commodity acquisition information including commodity information allowing to specify the target commodity to a corresponding system so that, for example, a user can acquire the physical commodity at a cash register or the user's home. In a case where the target commodity is an electronic commodity, the assist server 2 transmits commodity acquisition information including site information for allowing a user to download the electronic commodity together with commodity information to the POS system 5. The POS system 5 issues a ticket on which the site information included in the commodity acquisition information is printed, when the payment of the commodity at the cash register based on the purchasing target information is completed.

In FIGS. 10 and 11, a plurality of steps (processes) are sequentially shown, but steps performed in the second exemplary embodiment and an operation order of the steps are not limited to only the examples of FIGS. 10 and 11. For example, (S101) and (S102) may be performed in parallel with (S103) to (S106). As in the example of FIG. 12, in a case where the position of the portable object 52 is scarcely changed until the user moves away from the table 50, once (S101) and (S102) are performed, these steps do not need to be performed again until the position of the portable object changes or the portable object 52 is moved away.

Operations and Effects in Second Exemplary Embodiment

As described above, in the second exemplary embodiment, a commodity symbol corresponding to a physical commodity or an electronic commodity is projected onto a projection surface such as the table 50. The position of a portable object disposed on a projection surface, the position of a user's specific body part, and a projection position of a commodity symbol are specified based on sensor information obtained by the three-dimensional sensor 17. Further, a user identification symbol included in the portable object is detected. An operation using the user's specific body part with respect to the projected commodity symbol is detected, and the position of the commodity symbol on the projection surface is changed in accordance with the user's operation. In a case where the portable object and the commodity symbol have a predetermined positional relationship, user identification information obtained from the user identification symbol included in the portable object and commodity information corresponding to the commodity symbol are associated with each other. In the second exemplary embodiment, a user moves and operates a commodity symbol projected onto a projection surface using his or her specific body part so that the commodity symbol has a predetermined positional relationship with respect to a portable object having user identification information of the user himself or herself, thereby exhibiting such operations.

Also in the second exemplary embodiment, association information between commodity information and user identification information is used as purchasing target information in the POS system 5. For this reason, according to the second exemplary embodiment, by performing an operation of bringing a projected commodity symbol close to a portable object, the user can set a physical commodity or an electronic commodity corresponding to the commodity symbol as a candidate to be purchased. The user can purchase a physical commodity and an electronic commodity by simply disposing the portable object on a projection surface without having to use a user terminal such as a PC or a smart device and operating an image projected by the projection apparatus 18.

In this manner, in the second exemplary embodiment, it is possible to cause an actually existing portable object to virtually have a function of an electronic cart and to perform an operation using a user's specific body part with respect to commodity symbols, that is, virtual objects corresponding to physical commodities and electronic commodities that are not present on site. That is, according to the second exemplary embodiment, it is possible to achieve a completely new act of purchasing using an actually existing portable object and a virtual object, thus providing a user with a new purchase channel.

Further, according to the second exemplary embodiment, by transmitting commodity acquisition information including commodity information allowing to specify a target commodity to a corresponding system, a user can acquire a physical commodity purchased at a cash register or the user's home. In a case where the purchased commodity is an electronic commodity, commodity acquisition information includes site information for allowing the user to download the electronic commodity, and a ticket having the site information printed thereon is issued by the POS system 5. Thereby, the user can acquire the purchased electronic commodity by receiving the ticket issued after payment and accessing the site by means of his or her own user terminal using the site information printed on the ticket.

### Modification Example of Second Exemplary Embodiment

In the above-described second exemplary embodiment, a user's operation of bringing a commodity symbol close to a portable object is assumed. However, the same operations and effects can be obtained even in a case where a user's operation brings the portable object close to the commodity symbol which is projected. In this case, in FIG. 10, (S101) may be performed between (S104) and (S107).

In this case, the position of the commodity symbol may be fixed. In this modification example, the user position acquisition unit 61, the operation detection unit 63, and the position control unit 64 become unnecessary in an assist server 2. In a purchase assisting method according to this modification example, (S104), (S105), and (S106) become unnecessary in FIG. 10.

In the above-described second exemplary embodiment, there is no particular description of canceling the association between commodity information and user identification information, but cancellation may be performed using the same method as in the first exemplary embodiment. In this case, the symbol detection unit 66 further detects an operation symbol included in a portable object similar to the symbol detection unit 23, and the association unit 67 associates user identification information with commodity information and cancels the association in accordance with a detection situation of the operation symbol, similar to the association unit 24. For example, the association unit 67 specifies a commodity symbol having a predetermined positional relationship with respect to a detection position of an operation symbol or the position of a portable object included in the operation symbol. The association unit 67 cancels the existing association between information on a commodity corresponding to the specified commodity symbol and user identification information obtained using the detected user identification symbol. In this case, in the purchase assisting method, (S36), (S37), and (S38) of FIG. 4 are performed instead of (S108) in FIG. 10.

In the second exemplary embodiment, the cancellation may be performed using a method different from that in the first exemplary embodiment. For example, the projection processing unit 62 extracts a list of associations between commodity information and user identification information from the retaining unit 68 and transmits image information indicating the list to the projection apparatus 18, to thereby project a list screen of the associations onto a projection surface. The operation detection unit 63 detects an operation of selecting an association which is a cancellation candidate in the projected list screen and an operation of canceling the selected association. The association unit 67 deletes the selected association from the retaining unit 68 based on the selected operation and the cancellation operation which are detected by the operation detection unit 63. In addition, the assist server 2 further includes a processing unit that detects an operation gesture, and may cancel the existing association between information on a commodity and user identification information from the detected operation gesture.

### Modification Example of First Exemplary Embodiment and Second Exemplary Embodiment

In the above-described exemplary embodiments, although the recognition unit 22 and the recognition unit 65 recognize a portable object and specify the position of the portable object, only a portion of the portable object or the entirety and a portion of the portable object may be recognized, and the position of only a portion of the portable object or the position of the entirety and the position of a portion of the portable object may be specified. The recognized portion of the portable object is, for example, a pattern provided to the portable object, a partial shape, or the like. For example, the above-described operation symbol may be recognized as a portion of the portable object.

In this case, the assist server 2 recognizes a portion of the portable object 7 in (S32) of FIG. 4, and the assist server 2 specifies the position of the recognized portion of the portable object in (S33) of FIG. 4. In (S35) of FIG. 4, the assist server 2 determines whether or not a commodity having a predetermined positional relationship with respect to the portable object 7 is present based on the position of the commodity and the position of the portion of the portable object 7 which is specified in (S33). In addition, the assist server 2 specifies the position of a portion of a portable object in (S101) of FIG. 10, and the assist server 2 determines whether or not a commodity symbol and a portion of the portable object have a predetermined positional relationship in (S107) of FIG. 10.

In addition, as the above-described portable object, a portion of a person's body can be used. Accordingly, the above-described portable object can be considered as simply an object. In this case, as a user identification symbol, a fingerprint, a palm print, a vein, an iris, a face, or the like can be used. The assist server 2 (association units 24 and 67) can extract biological information (biological feature amount) as the user identification information from the user identification symbol using a well-known method and associate the biological information with information on a commodity.

Supplement to First Exemplary Embodiment and Second Exemplary Embodiment

The above-described user identification symbol and user identification information may allow to completely identify each user or may allow to identify the user in a predetermined range. In a case where a portable object is provided for each user, it is desired that the user identification symbol and the user identification information are user identification symbol and user identification information which allow to completely identify the user. However, a portable object may not be provided for each user as in a case where a portable object which is used in a store is set to be installed in the store and is shared among customers. In this case, a user identification symbol and user identification information may allow to identify users within a range that the users are customers who are present in a store in the same time zone. In this case, the user identification symbol and the user identification information can also be referred to as a symbol and information that identify a portable object (object). In addition, the user identification symbol and the user identification information are used, finally, to specify commodity information of an object to be purchased, and thus can also be referred to as a symbol and information that identify an accounting unit (unit of settlement).

### Third Exemplary Embodiment

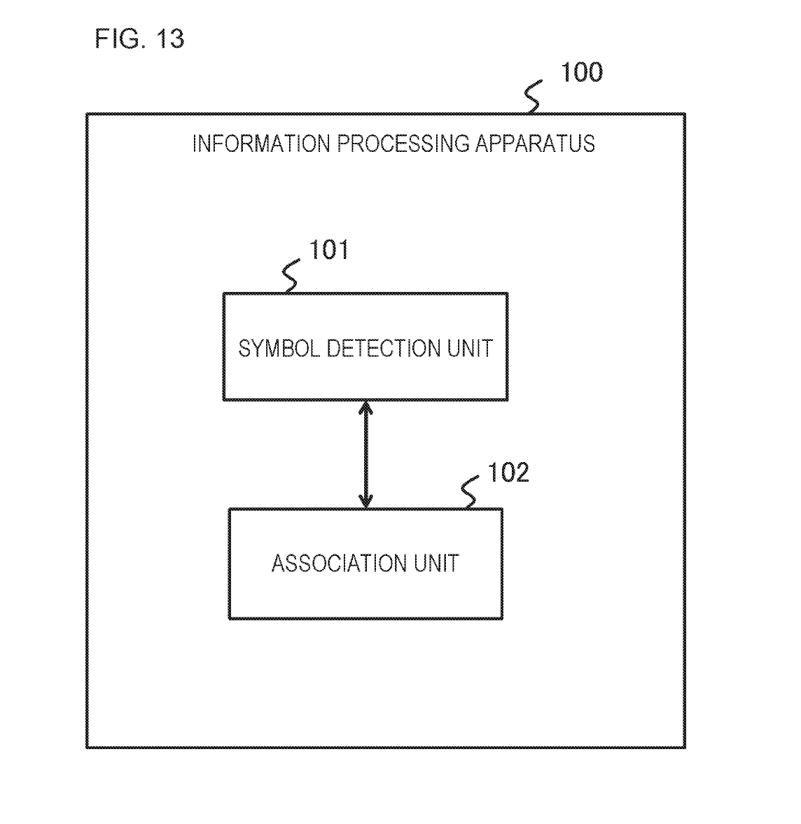

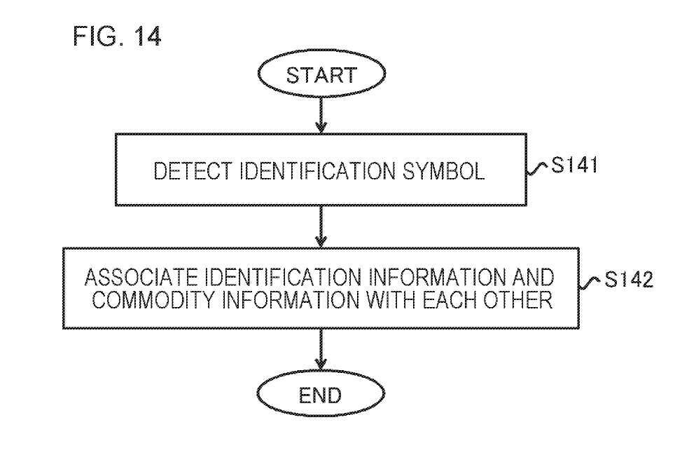

Hereinafter, an information processing apparatus and a purchase assisting method according to a third exemplary embodiment will be described with reference to FIGS. 13 and 14.

FIG. 13 is a schematic diagram showing a processing configuration example of an information processing apparatus according to a third exemplary embodiment. As shown in FIG. 13, an information processing apparatus 100 includes a symbol detection unit 101 and an association unit 102. The information processing apparatus 100 has the same hardware configuration as that of the above-mentioned assist server 2 shown in, for example, FIGS. 1 and 8, and a program is processed in the same manner as of the assist server 2, thereby achieving the above-mentioned processing units.

The symbol detection unit 101 detects an identification symbol included in an object based on sensor information. The sensor information may be any information insofar as the information can be used to detect an identification symbol of an object, and is a two-dimensional image, three-dimensional information, optical information such as visible light or infrared light, or the like. The object is an object including an identification symbol. However, it is desired that the object is a movable object. The object includes the above-mentioned portable object and a portion of a person's body. An identification symbol which is detected is similar to the above-mentioned user identification symbol, and is a symbol for identifying a user, an object including an identification symbol, an accounting unit (unit of settlement), or the like. Specific processing contents of the symbol detection unit 101 are the same as those of the symbol detection unit 23 and the symbol detection unit 66 that are mentioned above.

The association unit 102 associates identification information obtained using the detected identification symbol with information on the commodity in accordance with a positional relationship between a commodity or a commodity symbol corresponding to the commodity and an object including the detected identification symbol. Specific processing contents of the association unit 102 are the same as those of the association unit 24 and the association unit 67 that are mentioned above. The identification information associated with the commodity information is the same as the above-mentioned user identification information, and is information for identifying a user, an object including an identification symbol, a unit of payment (unit of settlement), or the like. The position of the entire object, the position of a portion of an object, the position of an attached object (a sticker or the like) which is movable together with an object and is attached to the object, or the like may be used for a positional relationship which is used to determine the association.

FIG. 14 is a flow chart showing an operation example of the information processing apparatus 100 according to the third exemplary embodiment. As shown in FIG. 14, a purchase assisting method according to the third exemplary embodiment is performed by at least one computer such as the information processing apparatus 100. For example, each process shown in the drawing is performed by each respective processing unit included in the information processing apparatus 100.

The purchase assisting method according to this exemplary embodiment includes detecting an identification symbol included in an object based on sensor information (S141), and associating, in accordance with a positional relationship between a commodity or a commodity symbol corresponding to the commodity and the object including the identification symbol detected in (S141) (S142), identification information obtained using the identification symbol detected in (S141) with information on the commodity. Here, (S141) is equivalent to (S34) of FIG. 4 and (S102) of FIG. 10, and (S142) is equivalent to (S37) of FIG. 4 and (S108) of FIG. 10.

In addition, the third exemplary embodiment may be related to a program causing at least one computer to execute the purchase assisting method or may be related to the at least one computer readable recording medium having the program recorded thereon.

In this manner, in the third exemplary embodiment, the recognition of the entirety or a portion of an object including a portable object is not necessarily required. This is because the position of an identification symbol detected from the object can be treated as the position of a portion of the object. That is, it is possible to determine the presence or absence of association between identification information and commodity information from a relationship between the position of the detected identification symbol (the position of a portion of the object) and the position of a commodity or a commodity symbol. A method of specifying the position of a commodity or a commodity identification symbol is as described in the above-described exemplary embodiments and modification examples.

According to the third exemplary embodiment, it is possible to obtain the same operations and effects as those in the above-described first and second exemplary embodiments.

The above-described exemplary embodiments will be described below in more detail by taking an example. The invention is not limited to the following example.

### EXAMPLE

In the above-described second exemplary embodiment, the position of a user's specific body part and the position of a commodity symbol which are mapped on a common three-dimensional coordinate space are used in order to detect the user's operation with respect to the projected commodity symbol. Accordingly, in order to simplify processing, it is desired that a direction of a sensing axis of the three-dimensional sensor 17 and a direction of a projection axis of the projection apparatus 18 are parallel to each other.

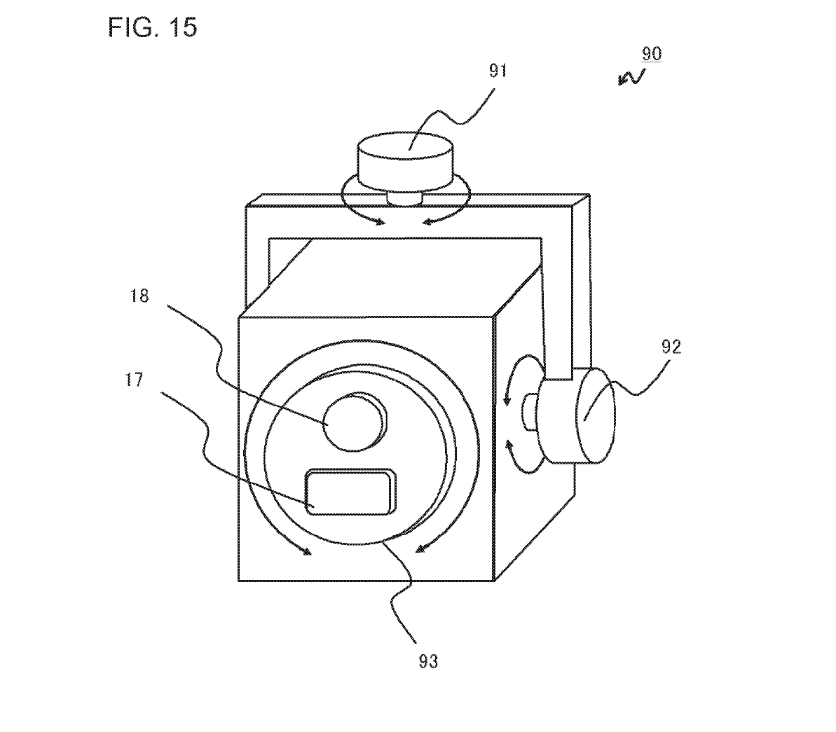

FIG. 15 is a diagram showing a configuration example of an interactive projection device (hereinafter, referred to as an IP device). An IP device 90 shown in FIG. 15 includes a three-dimensional sensor 17 and a projection apparatus 18 so that a direction of a sensing axis and a direction of a projection axis become parallel to each other. In addition, the IP device 90 includes direction adjusting mechanisms 91, 92, and 93 which allow to adjust directions of a projection axis and a sensing axis. The direction adjusting mechanism 91 allows to change each direction in the horizontal direction of the page of the drawing, the direction adjusting mechanism 92 allows to change each direction in the vertical direction of the page of the drawing, and the direction adjusting mechanism 93 allows to rotate each direction on the page of the drawing. Here, the IP device 90 sets the three-dimensional sensor 17 and the projection apparatus 18 to be fixed, and can also adjust directions of a projection axis and a sensing axis by a movable mirror or an optical system.

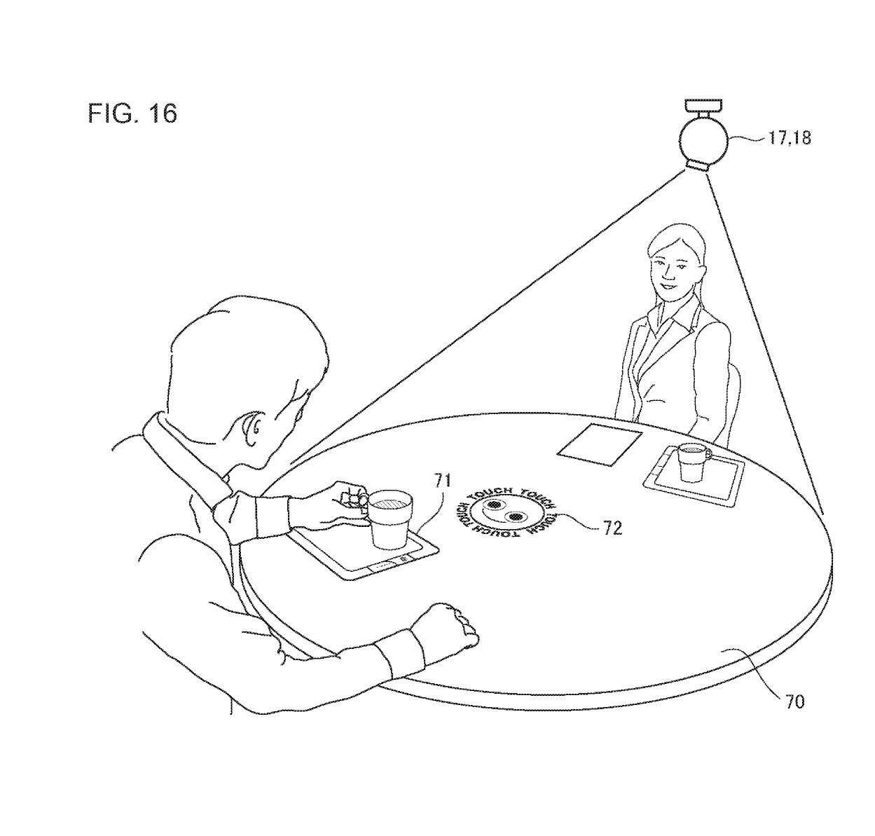

Hereinafter, the assist system 1 and the purchase assisting method according to the example will be described with reference to FIGS. 16 to 22. The place for carrying out this example is a coffee shop.

FIG. 16 is a schematic diagram showing an operation scene of this example. In this example, the entire upper surface of a table 70 for customers is used as a projection surface, and a three-dimensional sensor 17 and a projection apparatus 18 are fixedly installed above the table 70 with a direction toward the table 70 as the sensing direction and the projection direction. In the example of FIG. 16, the table 70 is shared by a plurality of customers. A tray 71 is used as an object (portable object), and a customer places the tray 71 with a cup of coffee in a range of the table 70 near him/herself and drinks the coffee.

The assist server 2 makes the projection apparatus 18 project a screen 72 as an initial screen onto the table 70. Here, the screen 72 is projected in the center of the table 70 so as to be operable by all of the customers sharing the table 70.

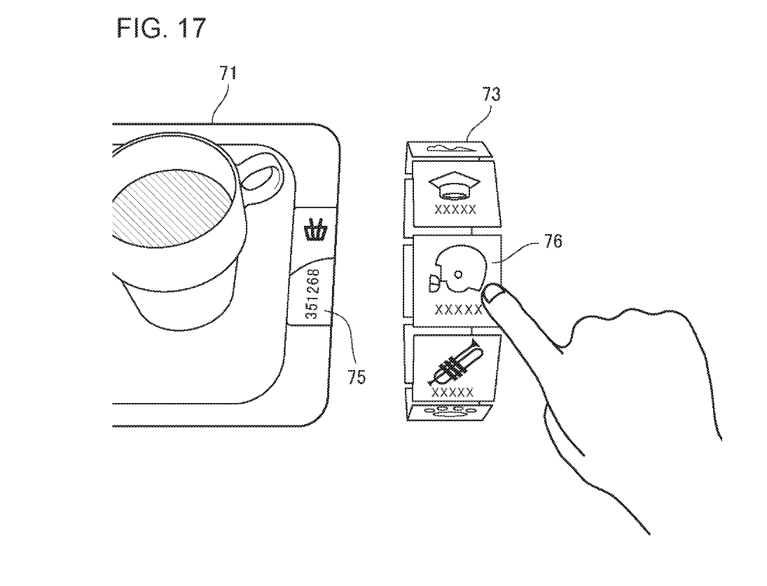

The assist server 2 detects a user's operation using the user's fingertip (specific body part) with respect to the screen 72 based on sensor information from the three-dimensional sensor 17. When the user's operation of drawing the screen 72 to his/her side is detected, the assist server 2 switches the screen 72 to a menu screen 73 shown in FIG. 17. The menu screen 73 is projected by the projection apparatus 18 based on image information transmitted by the projection processing unit 62.

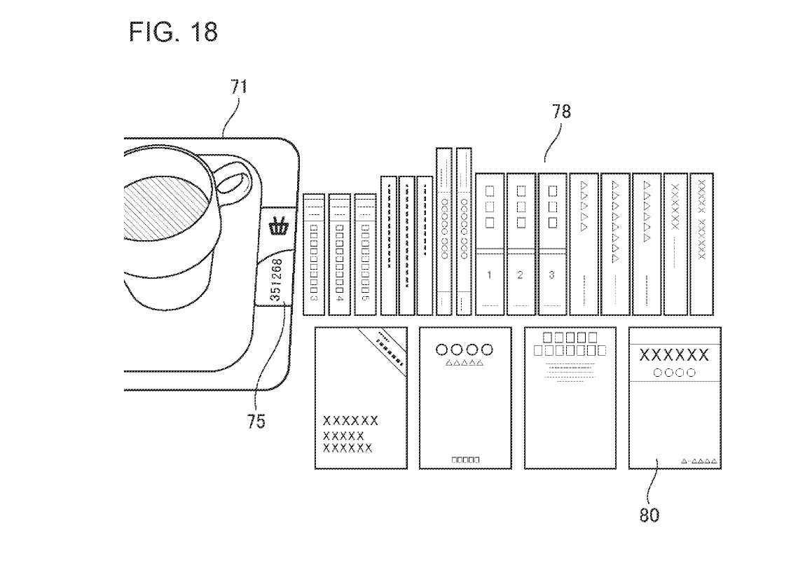

FIG. 17 is a diagram showing an example of a menu screen. A plurality of menus are formed in the menu screen 73 so as to be rolled. The assist server 2 detects that a menu 76 of an electronic book is touched by the user's fingertip, and causes the projection apparatus 18 to project an electronic books list screen 78 as shown in FIG. 18.

FIG. 18 is a diagram showing an example of an electronic books list screen. A plurality of book images indicating different electronic books are displayed on the list screen 78 as shown in FIG. 18. In this example, each book image is equivalent to a commodity symbol.

As shown in FIGS. 17 and 18, an identification symbol 75 is attached to the tray 71. A specific identification symbol 75 is attached to each tray 71 provided in the coffee shop. The assist server 2 recognizes the tray 71 based on sensor information from the three-dimensional sensor 17 and specifies the position of the tray 71. Further, the assist server 2 detects an identification symbol “351268” provided to the tray 71.

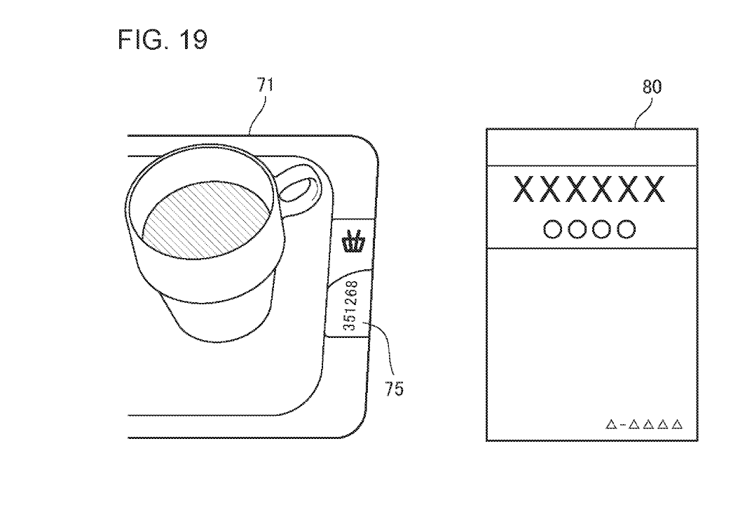

A customer performs an operation of selecting a desired electronic book from the electronic books list screen 78. At this time, the assist server 2 detects that a customer's fingertip touches a book image 80 indicating a certain electronic book in the electronic books list screen 78, based on sensor information from the three-dimensional sensor 17. The assist server 2 causes the projection apparatus 18 to project an enlarged book image 80 in accordance with the detection, as shown in FIG. 19.

FIG. 19 is a diagram showing an example of a book image. At this time, the assist server 2 can also perform control to allow a free trial reading of the electronic book indicated by the book image 80.

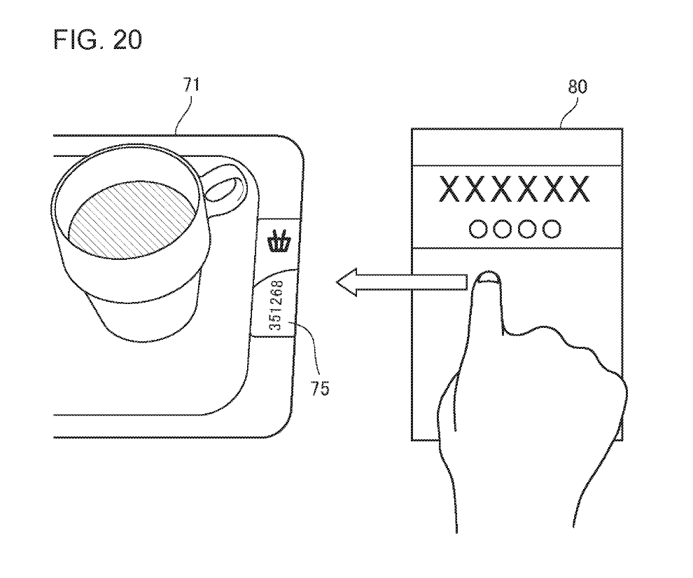

FIG. 20 is a diagram showing an example of a user's operation with respect to a book image (commodity symbol). A customer performs an operation of inputting the book image 80 indicating an electronic book which is a candidate to be purchased into the tray 71 using his or her fingertip. The assist server 2 changes the position of the book image 80 on the table 70 in accordance with the movement operation of the book image 80. When the assist server 2 determines that a positional relationship between the book image 80 and the tray 71 is a relationship in which a portion of the book image 80 overlaps the tray 71, the assist server erases the book image 80, associates commodity information on the electronic book corresponding to the book image 80 with a numerical value (ID) obtained through character recognition with respect to the detected identification symbol 75, and retains the association.

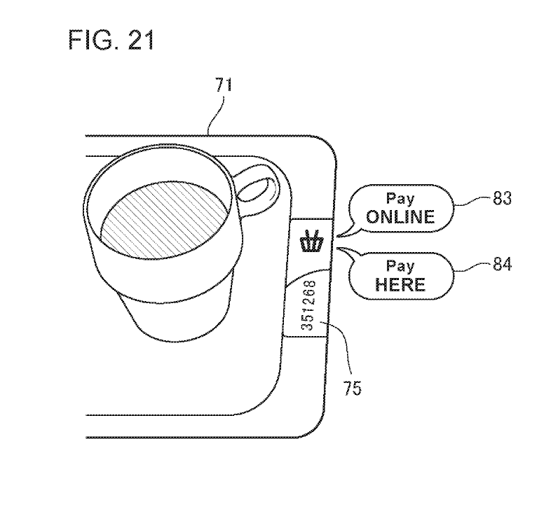

FIG. 21 is a diagram showing an example of a projection image after a commodity is input. The assist server 2 erases the book image 80 as described above, and then causes the projection apparatus 18 to project interface images 83 and 84 for selecting either one of payment at a cash register in the coffee shop and on-line settlement as shown in FIG. 21. In the example of FIG. 21, the assist server 2 projects the operation image 83 corresponding to on-line settlement and the operation image 84 corresponding to payment at the cash register at positions close to the tray 71. Thereby, the customer can select a method of payment by bringing his or her fingertip into contact with any one of the operation image 83 and the operation image 84.

In a case where the customer selects payment at the cash register, the customer brings the tray 71 to the cash register at any timing and presents the tray 71 to a cash register clerk. The cash register clerk makes a second image sensor 6 read the identification symbol 75 of the tray 71. The assist server 2 acquires sensor information obtained by the second image sensor 6, and acquires the identification information “351268” from the center information. The assist server 2 specifies commodity information (information on the electronic book corresponding to the book image 80) which is associated with the identification information “351268” from the held association information between the identification information and the commodity information, and transmits purchasing target information, including the commodity information, and commodity acquisition information to a POS system 5 of the coffee shop. Here, since the electronic book is set as an object to be purchased, the commodity acquisition information includes site information for allowing a user to download the electronic book.

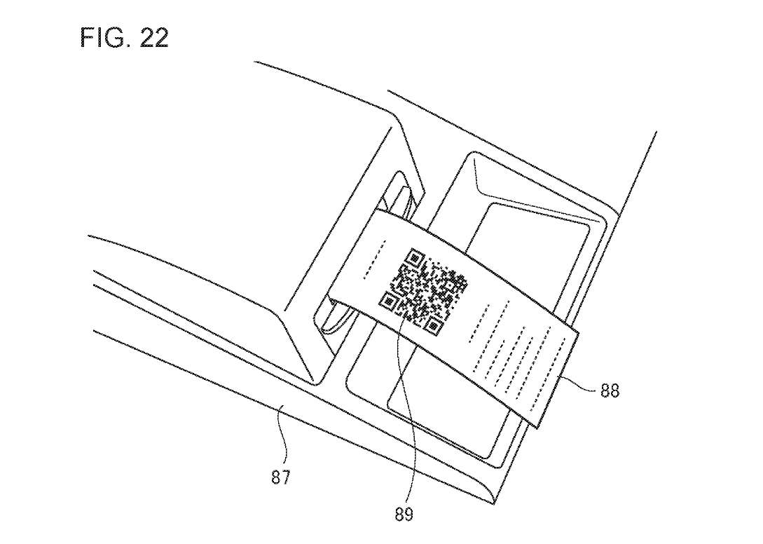

FIG. 22 is a schematic diagram showing the issuance of a ticket after payment at a cash register. A cash register device 87 of the POS system 5 performs an accounting process of the electronic book corresponding to the book image 80 based on the purchasing target information, and then issues a ticket 88 on which site information included in commodity acquisition information is printed. In the example of FIG. 22, site information is indicated by a QR code (registered trademark) 89. A customer having received the ticket can easily download the electronic book corresponding to the book image 80 onto the user terminal by having the user terminal read the QR code (registered trademark) 89.

On the other hand, in a case where on-line settlement is selected, the assist server 2 can project a screen for inputting user specific information (user ID or the like) for the on-line settlement onto the projection apparatus 18. As another example, the assist server 2 can also provide the user terminal with information for proceeding with the on-line settlement. The assist server 2 transmits the purchasing target information to an on-line settlement system and transmits the commodity acquisition information to the customer's user terminal after the settlement is completed. For example, the commodity acquisition information is transmitted to the user terminal by e-mail.

Meanwhile, in the above-described plurality of flow charts, a plurality of steps (processes) are sequentially described, but an operation order of the steps performed in the exemplary embodiments is not limited to the described order. In the exemplary embodiments, the order of steps shown in the drawings can be changed in a range that does not interfere with the contents thereof. In addition, the above-described exemplary embodiments and the modification examples can be combined with each other in a range in which the contents thereof are not contrary to each other.

Some or all of the above-described exemplary embodiments and the modification examples may also be specified as follows. However, the exemplary embodiments and the modification examples are not limited to the following description.

1. An information processing apparatus including:

a symbol detection unit that detects an identification symbol included in an object based on sensor information; and

an association unit that associates, in accordance with a positional relationship between a commodity or a commodity symbol corresponding to the commodity and the object including the detected identification symbol, identification information obtained using the detected identification symbol with information on the commodity.

2. The information processing apparatus according to 1, further including:

a retaining unit that retains the association between the identification information and the commodity information; and

a first output unit that acquires identification information, specifies commodity information associated with the acquired identification information in the retaining unit, to thereby output purchasing target information including the specified commodity information.

3. The information processing apparatus according to 2, further including:

a second output unit that acquires identification information, specifies commodity information on an electronic commodity associated with the acquired identification information in the retaining unit, to thereby output commodity acquisition information including site information for allowing a user to download the electronic commodity together with the specified commodity information.

4. The information processing apparatus according to any one of 1 to 3,

wherein the symbol detection unit further detects an operation symbol indicating cancellation, the operation symbol further included in the object in addition to the identification symbol, and

wherein the association unit specifies a commodity or a commodity symbol corresponding to the commodity which has a predetermined positional relationship with respect to a detection position of the operation symbol or a position of the object including the operation symbol, to thereby cancel an existing association between information on the specified commodity or information on the specified commodity symbol and identification information obtained using the detected identification symbol.

5. The information processing apparatus according to any one of 1 to 4, further including:

a commodity position specification unit that specifies a position of a commodity in an image obtained from an image sensor; and

a recognition unit that recognizes the object in the image by using the image obtained from the image sensor as the sensor information, to thereby specify a position of the recognized object in the image,

wherein the symbol detection unit detects an identification symbol included in the recognized object from the image by using the image obtained from the image sensor as the sensor information, and

wherein the association unit associates the identification information with the commodity information in accordance with a relationship between a position of the specified commodity and a position of the specified object.

6. The information processing apparatus according to any one of 1 to 4, further including:

a projection processing unit that causes a projection apparatus to project the commodity symbol; and

a recognition unit that recognizes the object based on the sensor information obtained from a three-dimensional sensor, to thereby specify a position of the recognized object,

wherein the symbol detection unit detects the identification symbol using the sensor information obtained from the three-dimensional sensor, and

wherein the association unit associates the identification information with the commodity information in accordance with a relationship between a position of the object and a position of the commodity symbol.

7. The information processing apparatus according to 6, further including:

a user position acquisition unit that recognizes a user's specific body part based on the sensor information obtained from the three-dimensional sensor, to thereby acquire positional information of the recognized specific body part;

an operation detection unit that detects a user's operation using the specific body part with respect to the commodity symbol based on positional information of the commodity symbol and positional information of the specific body part; and

a position control unit that changes a position of the commodity symbol in accordance with the detected user's operation,

wherein the association unit associates the identification information with the commodity information in accordance with a relationship between a position of the object and the position of the commodity symbol which is changed in accordance with the user's operation.

8. A purchase assisting method executed by at least one computer, the method including:

detecting an identification symbol included in an object based on sensor information; and

associating, in accordance with a positional relationship between a commodity or a commodity symbol corresponding to the commodity and the object including the detected identification symbol, identification information obtained using the detected identification symbol with information on the commodity.

9. The purchase assisting method according to 8, further including:

acquiring identification information;

specifying commodity information associated with the acquired identification information in a retaining unit that retains association between the identification information and commodity information; and

outputting purchasing target information including the specified commodity information.

10. The purchase assisting method according to 9, further including:

acquiring identification information;

specifying commodity information on an electronic commodity associated with the acquired identification information in the retaining unit; and

outputting commodity acquisition information including site information for allowing a user to download the electronic commodity together with the specified commodity information.

11. The purchase assisting method according to any one of 8 to 10, further including:

detecting an operation symbol indicating cancellation, the operation symbol further included in the object in addition to the identification symbol, and

specifying a commodity or a commodity symbol corresponding to the commodity which has a predetermined positional relationship with respect to a detection position of the operation symbol or a position of the object including the operation symbol; and

canceling an existing association between information on the specified commodity or information on the specified commodity symbol and identification information obtained using the detected identification symbol.

12. The purchase assisting method according to any one of 8 to 11, further including:

specifying a position of a commodity in an image obtained from an image sensor;

recognizing the object in the image by using the image obtained from the image sensor as the sensor information; and

specifying a position of the recognized object in the image,

wherein the detection of the identification symbol includes detecting an identification symbol included in the recognized object from the image using an image obtained from the image sensor as the sensor information, and

wherein the association includes associating the identification information with the commodity information in accordance with a relationship between a position of the specified commodity and a position of the specified object.

13. The purchase assisting method according to any one of 8 to 11, further including:

causing a projection apparatus to project the commodity symbol;

recognizing the object based on the sensor information obtained from a three-dimensional sensor; and

specifying a position of the recognized object,

wherein the detection of the identification symbol includes detecting the identification symbol using the sensor information obtained from the three-dimensional sensor, and

wherein the association includes associating the identification information with the commodity information in accordance with a relationship between a position of the object and a position of the commodity symbol.

14. The purchase assisting method according to 13, further including:

recognizing a user's specific body part based on the sensor information obtained from the three-dimensional sensor;

acquiring positional information of the recognized specific body part;

detecting a user's operation using the specific body part with respect to the commodity symbol based on positional information of the commodity symbol and positional information of the specific body part; and

changing a position of the commodity symbol in accordance with the detected user's operation,

wherein the association includes associating the identification information with the commodity information in accordance with a relationship between a position of the object and the position of the commodity symbol which is changed in accordance with the user's operation.

15. A program causing at least one computer to execute the purchase assisting method according to any one of 8 to 14.

16. A computer readable recording medium storing a program causing at least one computer to execute the purchase assisting method according to any one of 8 to 14 or a computer program product having the program embedded therein.

The application is based on Japanese Patent Application No. 2014-086508 filed on Apr. 18, 2014, the content of which is incorporated herein by reference.

1. An information processing apparatus comprising:
a symbol detection unit that detects an identification symbol included in an object based on sensor information; and
an association unit that associates, in accordance with a positional relationship between a commodity or a commodity symbol corresponding to the commodity and the object including the detected identification symbol, identification information obtained using the detected identification symbol with information on the commodity.

2. The information processing apparatus according to claim 1, further comprising:
a retaining unit that retains the association between the identification information and the commodity information; and
a first output unit that acquires identification information, specifies commodity information associated with the acquired identification information in the retaining unit, to thereby output purchasing target information including the specified commodity information.

3. The information processing apparatus according to claim 2, further comprising:
a second output unit that acquires identification information, specifies commodity information on an electronic commodity associated with the acquired identification information in the retaining unit, to thereby output commodity acquisition information including site information for allowing a user to download the electronic commodity together with the specified commodity information.

4. The information processing apparatus according to claim 1,
wherein the symbol detection unit further detects an operation symbol indicating cancellation, the operation symbol further included in the object in addition to the identification symbol, and
wherein the association unit specifies a commodity or a commodity symbol corresponding to the commodity which has a predetermined positional relationship with respect to a detection position of the operation symbol or a position of the object including the operation symbol, to thereby cancel an existing association between information on the specified commodity or information on a commodity corresponding to the specified commodity symbol and identification information obtained using the detected identification symbol.

5. The information processing apparatus according to claim 1, further comprising:
a commodity position specification unit that specifies a position of a commodity in an image obtained from an image sensor; and
a recognition unit that recognizes the object in the image by using the image obtained from the image sensor as the sensor information, to thereby specify a position of the recognized object in the image,
wherein the symbol detection unit detects an identification symbol included in the recognized object from the image by using the image obtained from the image sensor as the sensor information, and
wherein the association unit associates the identification information with the commodity information in accordance with a relationship between a position of the specified commodity and a position of the specified object.

6. The information processing apparatus according to claim 1, further comprising:
a projection processing unit that causes a projection apparatus to project the commodity symbol; and
a recognition unit that recognizes the object based on the sensor information obtained from a three-dimensional sensor, to thereby specify a position of the recognized object,
wherein the symbol detection unit detects the identification symbol using the sensor information obtained from the three-dimensional sensor, and
wherein the association unit associates the identification information with the commodity information in accordance with a relationship between a position of the object and a position of the commodity symbol.

7. The information processing apparatus according to claim 6, further comprising:
a user position acquisition unit that recognizes a user's specific body part based on the sensor information obtained from the three-dimensional sensor, to thereby acquire positional information of the recognized specific body part;
an operation detection unit that detects a user's operation using the specific body part with respect to the commodity symbol based on positional information of the commodity symbol and positional information of the specific body part; and
a position control unit that changes a position of the commodity symbol in accordance with the detected user's operation,
wherein the association unit associates the identification information with the commodity information in accordance with a relationship between a position of the object and the position of the commodity symbol which is changed in accordance with the user's operation.

8. A purchase assisting method executed by at least one computer, the method comprising:
detecting an identification symbol included in an object based on sensor information; and
associating, in accordance with a positional relationship between a commodity or a commodity symbol corresponding to the commodity and the object including the detected identification symbol, identification information obtained using the detected identification symbol with information on the commodity.

9. A non-transitory computer readable medium storing a program causing at least one computer to execute a purchase assisting method, the purchase assisting method comprising:
detecting an identification symbol included in an object based on sensor information; and
associating, in accordance with a positional relationship between a commodity or a commodity symbol corresponding to the commodity and the object including the detected identification symbol, identification information obtained using the detected identification symbol with information on the commodity.
